(19) United States
(12) Patent Application Publication
(10) Pub. No.: US 2026/0300697 A1
(43) Pub. Date: Oct. 1, 2026

(54) Methods and Systems for Non-Generative, Generative Artificial Intelligence

(71) Applicant: Artificial Genius Inc., Venice, CA (US)

(72) Inventor: Paul Burchard, Venice, CA (US)

(21) Appl. No.: 19/634,705

(22) Filed: Mar. 31, 2026

Related U.S. Application Data
(60) Provisional application No. 63/781,450, filed on Apr. 1, 2025.
(60) Provisional application No. 63/980,558, filed on Feb. 11, 2026.

(51) Int. Cl. G06N 3/0475; G06N 3/092

(52) U.S. Cl. CPC G06N 3/0475; G06N 3/092

(57) ABSTRACT

Aspects herein describe methods of training a Non-Generative, Generative (e.g., a non-hallucinatory artificial intelligence model). A computing device selects a generative artificial intelligence model and receives source data from at least one of a natural source or a synthetic source. The computing device generates augmented training data comprising one or more items of non-answerable, non-generative data. The computing device configures the generative artificial intelligence model for non-generative use using the augmented training data. Upon receiving input text and an indication of a non-generative task, the configured model outputs a token sequence derived from the input text by processing the input text and the non-generative task. Based on the token sequence, the system outputs a non-hallucinatory answer to the non-generative task.

### CROSS REFERENCE TO RELATED APPLICATIONS

This application claims priority to provisional U.S. Application Ser. No. 63/781,450, filed Apr. 1, 2025, and entitled “METHODS AND SYSTEMS FOR PROVIDING EXTRACTIVE ARTIFICIAL INTELLIGENCE,” provisional U.S. Application Ser. No. 63/980,558, filed Feb. 11, 2026, and entitled “METHODS AND SYSTEMS FOR PROVIDING NON-GENERATIVE, GENERATIVE ARTIFICIAL INTELLIGENCE”; each of which is hereby incorporated by reference in its entirety for all purposes.

### FIELD

Aspects described herein relate to computers, software, and artificial intelligence. More particularly, aspects relate to the non-generative use of generative artificial intelligence. Specifically, for example, the non-generative use of generative artificial intelligence to prevent hallucinatory outputs in enterprise applications.

### BACKGROUND

Generative Artificial Intelligence has been a major focus of recent technological development but has struggled in enterprise applications due to problems with accuracy and relevance.

The accuracy problem, colloquially known as “hallucination,” creates potentially unbounded risks for enterprises, because the output of the generative model may be highly plausible, yet incorrect. Despite the underlying transformer model architecture having been invented in 2017 and having had many billions of dollars of engineering efforts devoted to solving this hallucination problem, conventional systems have not been able to provide a solution to this hallucination problem.

The relevance problem, colloquially known as the “median human” phenomenon, arises because a general-purpose generative model does not have the time- and situation-dependent context, specialized knowledge, or other information that would be brought to an enterprise problem by a human domain expert, causing such general-purpose generative models out to output irrelevant responses. For example, asking a generative model to “summarize” a document might produce an irrelevant response, because what might be relevant for a summary is highly dependent on the factors outlined above.

Nevertheless, generative models are the most fluent language models available today. If the accuracy and relevance problems could somehow be solved, the benefits for enterprise applications would be manifold. Accordingly, there exists a need for an accurate, efficient, and scalable solution to the accuracy and relevance problems in systems utilizing conventional generative artificial intelligence models. Achieving the until now elusive combination of reliability, accuracy, and relevance required for enterprise use of language models necessitates a shift in how language models are created and applied to obtain the maximum value from their capabilities. A perspective on the history of language models explains the need for a new paradigm.

In the early days of Artificial Intelligence, in the 1950s, when symbolic logic systems were the focus of research, the first generation of language models consisted of rule-based, deterministic systems. Although the failure modes of these early language models were bound by the rules, it was never possible to collect enough rules for such language models to ever achieve a sufficient level of language fluency.

In the 1980s, researchers started to develop a second generation of language models that consisted of probabilistic systems. This research direction achieved practical utility with the invention of the transformer model in 2017, which identified a well-chosen set of statistics deemed sufficient for the probabilistic language model to learn in order to generate fluent-sounding language. These statistics consisted of correlations between pairs of language tokens with arbitrarily large distance between their textual locations, a set of statistics which was only quadratically expensive in the length of the text, in contrast to earlier n-gram statistics, which would have had to be exponentially expensive to include the same distant correlation statistics between tokens.

Despite the achievement of apparent language fluency, a problem for this second generation of probabilistic language models has been that this core probabilistic output generation, based on simple token correlation statistics, results in “hallucinatory” output that appears highly plausible, but is not grounded in any factual basis. The risks of such hallucinatory output of probabilistic language models, unlike the first generation of deterministic language models, are unbounded, with potentially disastrous outcomes for people or organizations relying on such outputs.

### SUMMARY

The following presents a simplified summary of various aspects described herein. This summary is not an extensive overview and is not intended to identify key or critical elements or to delineate the scope of the claims. The following summary merely presents some concepts in a simplified form as an introductory prelude to the more detailed description provided below.

There is no known mathematically possible solution to fix the hallucinatory generative process without a fundamentally different approach to language modeling, which is the purpose of the present disclosure. The solution of the present disclosure to the dilemma, between the countervailing advantages and disadvantages of the deterministic and probabilistic approaches to language modeling, is to introduce a new and third generation of language models, which are probabilistic on input, but deterministic on output. There is no known mathematically possible method to prevent second-generation models, such as the generative AI models described above, from hallucinating (e.g., constructing probabilistic outputs that produce false answers to tasks (e.g., questions)). Achieving determinism on output may only be mathematically possible via a seeming paradox: namely, by using a probabilistic, generative language model, but using it exclusively in a non-generative way, which does not require any of the model's probability information to produce the output. It is the extrapolative, generative process itself, inherent in second-generation models, which causes the hallucinations. As a result, in the new generation of model described herein a generative language model may be used strictly in a non-generative manner. The non-generative use of the model means that in principle, the model would not require probabilities to produce the required series of output tokens. Such a third-generation language model is described in the present disclosure as Non-Generative, Generative AI. This third-generation of language model may also be referred to as a non-hallucinatory model; a third-generation language model; a third-generation foundation model; a third-generation language non-hallucinatory foundation model; a Non-Generative, Generative AI; a Non-Generative, Generative AI model; a Non-Generative, Generative language model; or a Non-Generative, Generative model.

To understand the variety of output that could, at least in principle, be produced by a probabilistic model non-generatively, i.e., without the use of its probabilities, some examples are considered. One way to ensure non-generative output is if the desired output is a single piece of information, like a number or a name, that is derived from base text corresponding to an input task, such that outputting the desired output does not require any probabilities to extrapolate a long output token sequence. Such non-generative tasks (e.g., questions) may range in complexity from the simple case of a word or short phrase extracted literally from the text, to highly complex tasks (e.g., questions) that require significant work from the language model, like outputting a “yes” or “no”, for which the correct answer requires combining information from multiple locations in the text. Another way to ensure non-generative output is if the desired output is an exact quote from the text. Although this may end up being a long string of output tokens, no probabilities are required to produce such output, since the quote may be extracted deterministically from the input text. As can be seen, non-generative tasks (e.g., questions) are not limited by the complexity of the task itself, only by the requirement that the desired output token sequence may be produced without the need for information about model probabilities. Furthermore, other types of non-generative tasks (e.g., questions) may be readily identified by those skilled in the art of using probabilistic language models.

It is important to note, however, that non-generative use of a generative, probabilistic second-generation language model is only a theoretical loophole, to escape the mathematical impossibility of eliminating hallucinations for the generative use of such models. These second-generation models, in their original form, may still frequently hallucinate, even in non-generative use. To produce a third-generation language model as described herein, that is truly deterministic on output, the mathematical loophole may be actualized by post-training the second-generation model to follow the single anti-hallucination instruction not to make up an answer when the task (e.g., question) may not be answered. Effectively, the second-generation base model may be post-trained to eliminate the output probabilities that cause hallucinations. Note that such post-training may not work, by the impossibility theorem, for generative use of the model, but due to the loophole of non-generative use of a generative second-generation model, it is achievable for non-generative use. The post-training may also occur at any point in the loop of using the model; that is, training data may be generated after the model is initially trained but may be applied to a step where the model is further configured, refined, updated, or otherwise trained, such as part of an iterative feedback loop. The resulting, post-trained model has then become a third-generation, Non-Generative, Generative language model as described herein, per the method of this disclosure, that is deterministic on output. There are numerous methods, known to those skilled in the art of using probabilistic language models, that could be used to post-train a third-generation, Non-Generative, Generative AI model starting from a second-generation one, including but not limited to supervised or unsupervised fine tuning, direct preference optimization, proximal policy optimization, or reinforcement learning, with or without human feedback.

Finally, it is important to note that these third-generation, Non-Generative, Generative models may still, in an essential way, rely on the complete probability information trained into the model on input. This probability information may be necessary for the model to comprehend the input prompt, including all elements of the input, including system instructions, the input text, the task (e.g., question) being made against the input text, and any structural elements that identify or delineate these components within the prompt. This comprehension may be expressed in the form of an embedding vector for the entire prompt (not just any single element of it in isolation), that is represented by the activations of the final neural network layer when the prompt is provided as input. Note that the process of producing this embedding vector based on the probability weights is essentially an interpolative process, which is numerically stable and has bounded errors, due to the inherent structure of neural networks, with their linear matrix multiplications in each layer, followed by activation functions that are chosen not to amplify errors. This is in sharp contrast to the process of producing generative output using a second-generation language model, which uses the probability weights in an essentially extrapolative way, which may be highly unstable and lead to unbounded errors, as indicated above. This is why third-generation models of the present disclosure, although using large amounts of probability information, like second-generation models, to obtain a nuanced understanding of the input prompt, may still share the high reliability and bounded errors of first-generation models in their output.

Restricting the use of generative models to non-generative use is beneficial not only for accuracy, but also for relevance. Valuable enterprise tasks, such as summarization, which are not well-defined without a significant amount of context about the intended audience, and the purposes for which the task is desired, may be broken down into a plurality of non-generative sub-tasks that obtain contextually relevant information from the input, selected on the basis of domain expertise, and then reassembled into the desired summary. The same method to ensure relevance, via expert selection of non-generative sub-tasks, may be applied to many other enterprise tasks.

The methods and systems described herein provide specific technical improvements to the functioning of computing systems that process natural language. Conventional generative artificial intelligence models use probability weights in an essentially extrapolative manner during output token generation, which is computationally unstable and leads to unbounded errors in the form of hallucinatory outputs. The methods described herein improve the technical functioning of such computing systems by configuring the generative artificial intelligence model to use probability weights only on the input side, through an interpolative encoding process that is numerically stable and produces bounded errors due to the inherent structure of neural networks, with their linear matrix multiplications in each layer followed by activation functions that are chosen not to amplify errors. On the output side, the configured model generates token sequences deterministically, without probabilistic extrapolation, thereby eliminating the source of unbounded errors that cause hallucinations. Additionally, the augmented training data comprising non-answerable, non-generative data provides a specific technical mechanism for configuring the model to produce null responses when the requested information is not present in the input text, rather than consuming computational resources to generate plausible but incorrect output sequences. As a result, the configured non-hallucinatory model may produce outputs with the high reliability and bounded errors of first-generation deterministic language models, while retaining the language comprehension capabilities of second-generation probabilistic language models.

The foregoing general description of the illustrative embodiments and the following detailed description thereof are merely exemplary aspects of the teachings of this disclosure and are not restrictive.

The various aspects of the illustrative embodiments are substantially shown in and/or described in connection with at least one of the following figures, as set forth more completely in the claims.

These and other advantages, aspects, and novel features of the present disclosure, as well as details of illustrated embodiments, thereof, will be more fully understood from the following description and drawings.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 depicts an illustrative network environment that may be utilized in accordance with various embodiments;

FIG. 2 illustrates an example user device that may be used in a network environment, such as either a client device or a server in the network environment of FIG. 1, in accordance with illustrative aspects described herein;

FIG. 3 illustrates steps for configuring and using a non-hallucinatory model according to illustrative aspects described herein;

FIG. 4 illustrates steps for generating augmented training data comprising non-answerable, non-generative data from a natural source according to illustrative aspects described herein;

FIG. 5 illustrates steps for generating augmented training data comprising non-answerable, non-generative data from a synthetic source according to illustrative aspects described herein;

FIG. 6 illustrates steps for a search and indexing application using a configured non-hallucinatory model according to illustrative aspects described herein; and

FIG. 7 illustrates steps for a summarization application using a configured non-hallucinatory model according to illustrative aspects described herein.

### DETAILED DESCRIPTION

### I. Description for Providing Non-Generative, Generative Artificial Intelligence

### A. Method for Non-Generative, Generative Artificial Intelligence

The steps of the method described above for creating and using a third-generation, Non-Generative, Generative AI model are described further herein.

The first step may be to select a second-generation, Generative AI base model which is available and suitable for post-training (one could alternatively pretrain one's own second-generation model for this purpose, but that is a rather expensive undertaking). To make the process of producing a third-generation, Non-Generative, Generative AI model from this base model as simple as possible, some criteria may be applied to the base model selection that make it easier to use the base model non-generatively. If these criteria are not satisfied, then additional work may be required, in addition to the steps of the method explicitly detailed here, to make the model more amenable to non-generative use. Such criteria could include:
The base model is not naturally verbose or chatty;
The base model may answer a question without providing voluminous explanations, either naturally, or when given explicit instruction to answer the question without additional explanations, that could be included in the system prompt; and/or
The base model does not have any post-inference features that would complicate the post-training, such as reasoning or chain of thought features, that recursively chain multiple inference steps. Or if the model does have such features, it is possible to switch them off by altering the prompt.

The second step may be to prepare the post-training data that may be used to turn the second-generation base model into a third-generation Non-Generative, Generative AI model. This data preparation may be extensively detailed in the Preparation of Post-Training Data section below.

The third step may be to post-train the base model on the prepared data. The model may be post-trained by any training method, including but not limited to supervised or unsupervised fine tuning, direct preference optimization, proximal policy optimization, or reinforcement learning, with or without human feedback.

The fourth step may be to apply the resulting, third-generation, Non-Generative, Generative AI model to specific enterprise applications. Methods for useful such applications are detailed in the Illustrative Implementation section below.

It should be understood that variations within the third-generation models described herein are possible. For example, a model created using the methods described herein may be a purely non-hallucinatory language model. Such a model may be trained to distinguish strictly answerable from strictly non-answerable non-generative questions, and in practice, when given questions with some degree of ambiguity, will mostly refuse to answer them. Additionally, or alternatively, in some examples, a model trained as described herein may be configured to provide answers to questions up to a threshold degree of ambiguity. In these examples, a variety of controlled ambiguities of different types may be introduced into the post-training data. Such a model may include a degree of tolerance that allows the model to make a limited degree of judgment in determining whether a question is answerable and providing a most probable answer, rather than refusing to answer the question.

The controlled judgment calls that the second model has been trained to make do not result in a probabilistic outcome. The model gives the same deterministic output, including these judgment calls, every time. The ambiguity is instead handled deterministically on the input side, via embedding, and then a fine-tuning method makes sure that this decision gets translated into deterministic output.

### B. Preparation of Post-Training Data

Conventionally, a generative model is trained to predict a next token with the most plausible value, even in a non-generative task, and even if there is no information in the input on which to base this prediction. To solve the problems associated with conventional generative models, for a non-hallucinatory model as described herein, the training data (whether for pretraining, fine-tuning, reinforcement learning, or other training regimen) should be augmented with unanswerable (e.g., non-answerable), non-generative data. Many post-training methods perform best with training data that is somewhat balanced across different classes. For this reason, it is often beneficial to additionally augment the training data with answerable, non-generative data, if it is not already present.

Answerable and unanswerable (e.g., non-answerable) non-generative training data comprises data associated with a non-generative question, the answer to which either may (in the answerable case) or may not (in the unanswerable case) be extracted purely from the source data inputted, to the model, as training data. For example, each piece of non-generative training data comprises a token sequence comprising, in any order, (1) body text, (2) an non-generative question that asks for a piece of information from the body text, (3) either a response, in the answerable case, or a suitable non-response to the non-generative question, the latter distinguishable from an ordinary response to the non-generative question, in the unanswerable case, and (4) zero or more tokens to provide context for the previous constituents, such tokens serving as system instructions, to demarcate and/or name constituents, to disambiguate the non-generative task, or to serve other contextual purpose. A suitable non-response may be, for example, an indication that the correct response is unknown, undefined, a null value, etc. Unanswerable, non-generative training data is, then, non-generative training data for which constituent (2) asks for a piece of information from the body text that is not actually present in the body text, and constituent (3) consists only of a suitable non-response.

It is again important to note that the inclusion of such non-responsive training data may only prevent the resulting generative model from providing inaccurate output for non-generative tasks, not generative ones. If it is attempted to extend this training method to generative tasks, the generative model will not be able to learn how to avoid inaccurate generative output, due to the mathematical impossibility indicated above.

Additionally, or alternatively, the augmented training data may also include answerable, non-generative training data, in which the answer to the non-generative task (e.g., question) may be extracted from the body text. Many post-training methods perform best with training data that is somewhat balanced across different classes. For this reason, it may be beneficial to additionally augment the training data with answerable, non-generative data, if it is not already present.

This answerable and/or unanswerable (e.g., non-answerable), non-generative training data may be produced at scale by automated methods which will be apparent to those of ordinary skill in the art of preparation of training data for generative models. To provide additional guidance, two illustrative embodiments of this data production method will be detailed.

The first illustrative embodiment is a method for automatically producing the answerable and/or unanswerable (e.g., non-answerable), non-generative training data from a variety of suitable natural sources. For example, there are many natural sources of body-question-answer data that may be possible to put into non-generative form by filtering or post-processing. In most cases, these sources, by their nature, will only ask questions for which the answer may be found in the body, which is part of the reason that generative models often provide inaccurate output. But for the purposes of creating unanswerable, non-generative body-question-answer data, the answer, if present, may be efficiently ablated from the body (i.e., the data comprising the answer to the non-generative question may be removed from the training data). The reason this ablation is efficient is because the question is non-generative in nature, so that the information in the body that answers will typically be localized, or dependent on a few localized token sequences, and so it may be ablated with only small changes to the body. An illustrative implementation of this embodiment will be detailed below.

Additionally, or alternatively, the natural sources may include frequently asked questions (FAQ) documents, reading comprehension tests, standardized test preparation materials, technical manuals with troubleshooting guides, legal documents with associated interrogatories, medical records with diagnostic questions, or any other source that contains body text paired with tasks (e.g., questions) and corresponding answers.

The second illustrative embodiment is a method for producing the answerable and/or unanswerable (e.g., non-answerable), non-generative training data synthetically. For each item of training data, an existing generative model may be used to randomly generate body text. If sufficient metadata about the generated text is retained, allowing the identification of meaningful elements of the text, such as subjects, objects, verbs, or other elements, then corresponding non-generative questions of various types and of varying complexity may be also randomly generated, which may be logically determined to be either answerable or unanswerable from the generated text. Finally, the synthetic item of answerable or unanswerable, non-generative training data may be assembled as a sequence consisting of (1) the generated body text, (2) the generated non-generative question logically constructed to be either answerable or unanswerable, and (3) a suitable response or non-response.

Additionally, or alternatively, if sufficient metadata about the generated text is retained, allowing the identification of meaningful elements of the text, such as subjects, objects, verbs, or other elements, then corresponding non-generative tasks (e.g., questions) of various types and of varying complexity may also be randomly generated, which may be logically determined to be either answerable or unanswerable from the generated text.

It should be understood that the above methods of implementing the present disclosure are merely exemplary and that other methods for automatically producing the answerable and/or unanswerable (e.g., non-answerable), non-generative training data as described herein may be used without departing from the present disclosure.

### II. Illustrative System Architecture

In the following description of the various embodiments, reference is made to the accompanying drawings, which form a part hereof, and in which is shown by way of illustration various embodiments in which the aspects described herein may be practiced. It is to be understood that other embodiments may be utilized and structural and functional modifications may be made without departing from the scope described herein. Aspects are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging. Although the various illustrative embodiments described herein generally provide examples of using this system architecture to configure and apply a non-hallucinatory model for enterprise applications, it should be understood that this architecture may be used to configure and/or apply non-hallucinatory models for solving any domain-specific problems, as described herein, without departing from the scope of this disclosure.

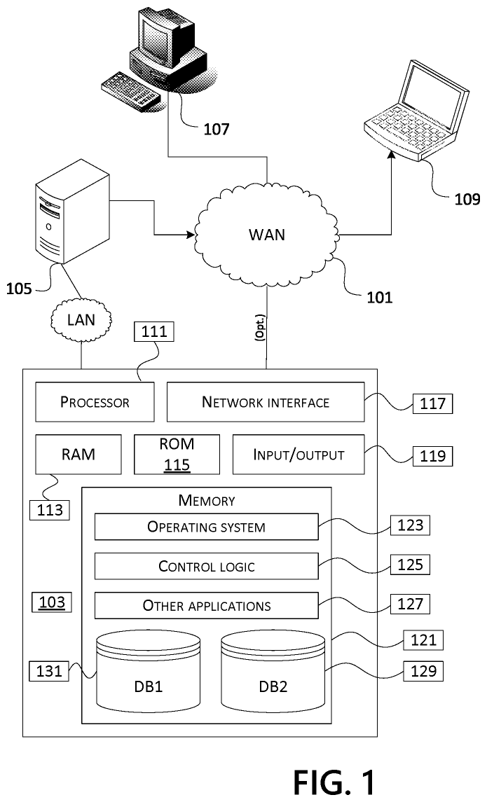

FIG. 1 illustrates one example of a network architecture and data processing device that may be used to implement one or more illustrative aspects. Various network nodes 103, 105, 107, and 109 may be interconnected via a wide area network (WAN) 101, such as the Internet. Other networks may also, or alternatively, be used, including private intranets, corporate networks, LANs, wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data, attributable to a single entity, which resides across all physical networks.

The components may include computational unit 103, web server 105, and client devices 107, 109. Computational unit 103 may be a general or special-purpose computer or computer farm. Computational unit 103 may be a computational unit that provides overall access, control and administration of databases and control software for performing one or more illustrative aspects described herein. Computational unit 103 may be connected to web server 105 through which users interact with and obtain data as requested. Alternatively, computational unit 103 may act as a web server itself and be directly connected to the Internet. Computational unit 103 may be connected to web server 105 through the network 101 (e.g., the Internet), via direct or indirect connection, or via some other network. Computational unit 103 may have significant ability to run multiple instances of the described method in parallel. Computational unit 103 may also have significant bandwidth for communication of data between multiple instances of described method. Users may interact with the computational unit 103 using remote devices 107, 109, e.g., using a web browser to connect to the computational unit 103 via one or more externally exposed web sites hosted by web server 105. Devices 107, 109 may be used in concert with computational unit 103 to access data stored therein or may be used for other purposes. For example, from device 107 a user may access web server 105 using an Internet browser, as is known in the art, or by executing a software application that communicates with web server 105 and/or computational unit 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and computational unit 103 may be combined on a single server.

Each component 103, 105, 107, 109 may be any type of known computer, server, or data processing device. Computational unit 103, e.g., may include a processor 111 controlling overall operation of the computational unit 103. Computational unit 103 may further include RAM 113, ROM 115, network interface 117, input/output interfaces 119 (e.g., keyboard, mouse, display, printer, etc.), and memory 121. I/O 119 may include a variety of interface units and drives for reading, writing, displaying, and/or printing data or files. Memory 121 may further store operating system software 123 for controlling overall operation of the data processing device 103, control logic 125 for instructing computational unit 103 to perform aspects described herein, and other application software 127 providing secondary, support, and/or other functionality which may or may not be used in conjunction with aspects described herein. The control logic may also be referred to herein as the computational unit software 125. Functionality of the computational unit software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

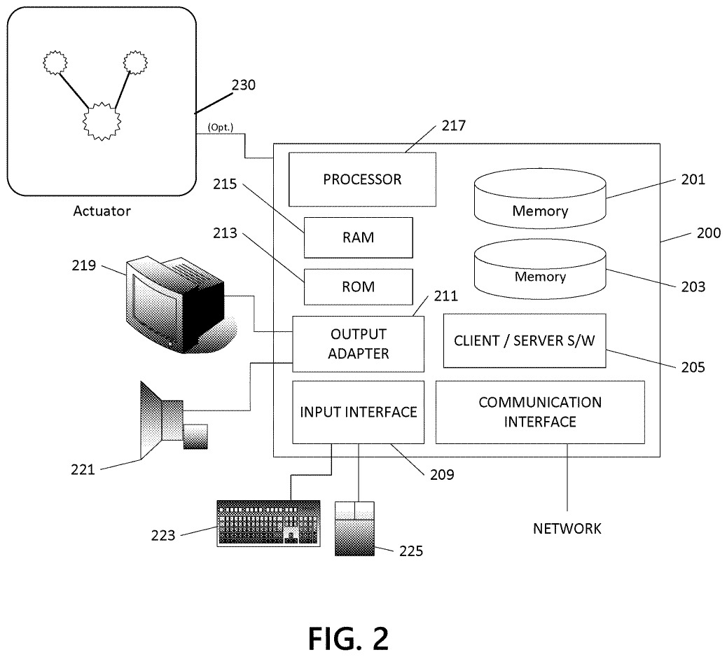

As described above, the computational unit 103 may perform methods described herein. FIG. 2 illustrates an example user device 200 such as device 107 (shown in FIG. 1) with which a user may access and communicate with computational unit 103. User device 200 and computational unit 103 may be part of the same device or may be separate devices. User device 200 may include a variety of components and modules including a processor 217, random access memory (RAM) 215, read only memory (ROM) 213, memories 201 and 203, which may include one or more collections of data, such as databases, client or server software 205, output adapter 211, input interface 209 and communication interface 207. Processor 217 may include a graphics processing unit (GPU) or a separate GPU may be included in the output adapter 211. Memory 201 may be configured to store electronic data, inclusive of any electronic information disclosed herein. Another memory, such as memory 203, may be configured to store different or overlapping data. In one embodiment, memories 201 and 203 may be a single, non-transitory computer-readable medium. Each memory 201, 203 may or may not include a database to store data or include data stored in RAM memory, accessed as needed by the client/server software. Data associated with the method described may be communicated between user device 200 and a computational unit 103 or a server through a transceiver or network interface, such as communication interface 207.

One or more statutory computer-readable mediums, such as medium 201 or 203 may be configured to contain client/server software (graphically shown as software 205). Software 205 may, in one or more arrangements, be configured to receive source data for processing (e.g., to produce non-answerable, non-generative training data as described herein) as well as facilitate or direct communications between two devices, including remote devices 109 and/or communications devices, among other devices. A user may control the device, through input interface 209 using various types of input devices including keyboard 223 and mouse 225. Other types of input devices may include a microphone (e.g., for voice communications over the network), joysticks, motion sensing devices, touchscreens 219 and/or combinations thereof. In one or more arrangements, music or other audio such as speech may be included as part of the user experience with the device. Further collection of source data may be facilitated through cameras, GPS, accelerometers, chemical detectors, or any other such input structures that may aid in gathering source data. In such instances, the audio may be outputted through speaker 221. Further, this source data used to produce the non-answerable, non-generative training data may be limited to a virtual world. In such embodiments, source data may be produced and inputted via computers or other computational units. Such observational worlds may include, but are not limited to, video games and simulator programs. In such embodiments, observational data may contain virtual data, such as virtual chemical compositions and virtual acceleration. Such source data may include instead or in addition to virtual sensory data, data regarding the state of a computational device which runs, compiles, or outputs such described virtual world. Data regarding the state of a computational device may include but is not limited to the amount of RAM/ROM currently being used, battery life, or the progression of a program.

In some embodiments, one or more actions suggested as query responses by the method described may be performed by actuators 230. These actuators 230 may comprise any structure or separate device which outputs directions to perform an action to a user or itself performs some of or all of the action dictated by the method described. Such actuators 230 may include, but are not limited to, various machines such as computing devices, display devices, printers, and/or other devices, appliances such as alarm clocks or washing machines, and robotic or artificially intelligent entities such as automated personal assistants. Such actuators 230 may be physically a part of user device 200 or computational unit (such as 103 shown in FIG. 1). Actuators 230 may also interact with user device 200 or computational unit 103 through a network (such as network 101 shown in FIG. 1). Actuator 230 may provide query responses (e.g., instructions, recommended actions, or the like), pattern mappings (e.g., information and/or representations of information gathered by performing the methods described herein), and/or other outputs of methods described herein. Actuator 230 also may be used to perform specific non-generative tasks which may be inputted into the method described. In a real-world setting, actuator 230 may perform any of a myriad of tasks including but not limited to displaying extracted information, generating formatted summaries, updating database records, triggering enterprise workflow actions, and/or other functions.

Software 205, computer executable instructions, and other data used by processor 217 and other components of user device 200 may be stored in memories, 201, 203, RAM 215, ROM 213 or a combination thereof. Other types of memory may also be used, including both volatile and nonvolatile memory. Software 205 may be stored within RAM 215, ROM 213 and/or memories 201 and 203 to provide instructions to processor 217 such that when the instructions are executed, processor 217, device 200 and/or other components thereof are caused to perform functions and methods described herein. In one example, instructions for generating a user interface for interfacing with a server 105 or user device 107 may be stored in RAM 215, ROM 213 and/or databases 201 and 203. Software 205 may include both applications and operating system software, and may include code segments, instructions, applets, pre-compiled code, compiled code, computer programs, program modules, engines, program logic, and combinations thereof. Computer executable instructions and data may further be stored on some physical form of computer readable storage media (referred to herein as “computer memory”) including, e.g., electrically erasable programmable read-only memory (EEPROM), flash memory or other memory technology, CD-ROM, DVD or other optical disk storage, magnetic cassettes, magnetic tape, magnetic storage and the like. Software 205 may operate to accept and process observational data so that it may be used by the methods described. There may also be software 205 that relays actions dictated by the methods to the user. In some cases such software 205 may produce a text or voice list of instructions. Also, software 205 may allow an actuator to perform an action recommended by the method.

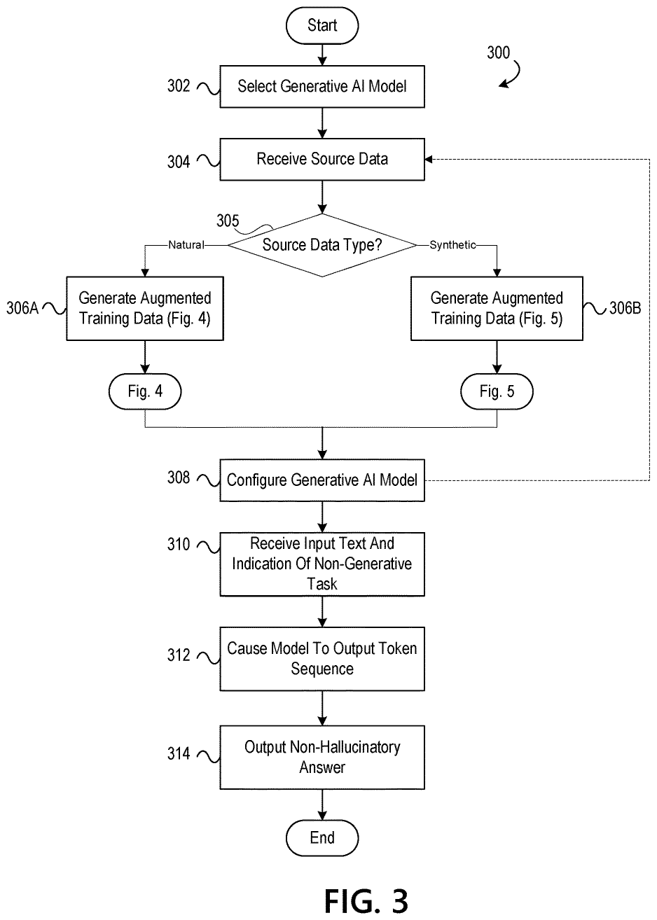

FIG. 3 illustrates an example method 300 for configuring and applying a non-hallucinatory model according to one or more embodiments. At step 302, a computing device (e.g., computational unit 103 as shown in FIG. 1) may select a generative artificial intelligence model. For example, the computing device may select a generative artificial intelligence model to serve as the base model for creating a new, third-generation, non-hallucinatory (i.e., non-generative, generative) model as described herein. The generative artificial intelligence model may be a second-generation, probabilistic language model suitable for post-training. To make the process of producing a third-generation, Non-Generative, Generative AI model from this base model as simple as possible, some criteria may be applied to the base model selection that make it easier to use the base model non-generatively. Such criteria may include: a base model that may not be naturally verbose or chatty; a base model that may be configured to answer a task (e.g., question) without providing explanations exceeding a predetermined threshold length (e.g., a threshold word count, a threshold page count, or the like); and/or a base model that may not have any post-inference features that would complicate the post-training, such as reasoning (e.g., trace visibility providing a trace of how the model arrived at a solution, agentic tool use allowing the model to determine when to use certain tools such as web searching, code execution, image generation, or the like, and/or other reasoning features) or chain of thought (e.g., breaking down a complex query into smaller, logical steps before providing a response/answer) features, or if the model does have such features, it may be possible to switch them off. In some examples, the selection of the generative artificial intelligence model may be performed based on receiving user input (e.g., via an input/output interface 119). In some configurations, the selection of the generative artificial intelligence model may be performed automatically, without manual intervention, based on predetermined criteria, instructions, or rules stored in memory (e.g., memory 121).

At step 304, the computing device may receive source data. For example, the computing device may receive source data from at least one of a natural source or a synthetic source or a combination thereof. Natural sources may include textbooks, electronic documents, question-answer datasets, or observational data captured by one or more devices. Synthetic sources may include data generated by causing a generative model to generate body text, randomly selecting a sentence in the body text, identifying an item of information in the selected sentence, and transforming the selected sentence into a non-generative task (e.g., question). The computing device may receive the source data via user input at the computing device (e.g., via an input/output interface 119), and/or from a different computing device such as user device 200 (e.g., via an input interface 209 through an input device such as keyboard 223 or mouse 225). It should be understood that this is merely an example, and that other source data may be used, as described herein. It should also be understood that the computing device may use various different source data, without departing from the scope of this disclosure.

At decision 305, a source data type may be determined. If the source data is a natural source, the computing device may proceed to step 306A. If the source data is a synthetic source, the computing device may proceed to step 306B. Additionally, or alternatively, the computing device may receive source data from both natural and synthetic sources, in which case the computing device may proceed to both step 306A and step 306B. In some embodiments, the computing device may process natural source data and synthetic source data in parallel, sequentially, or in any combination. It should be understood that the decision 305 is merely illustrative, and that the determination of source data type may be performed automatically by the computing device, manually by a user, or by any other suitable method without departing from the scope of this disclosure. It should also be understood that these are merely examples, and that other source data may be used, as described herein. The computing device may use various different source data, without departing from the scope of this disclosure.

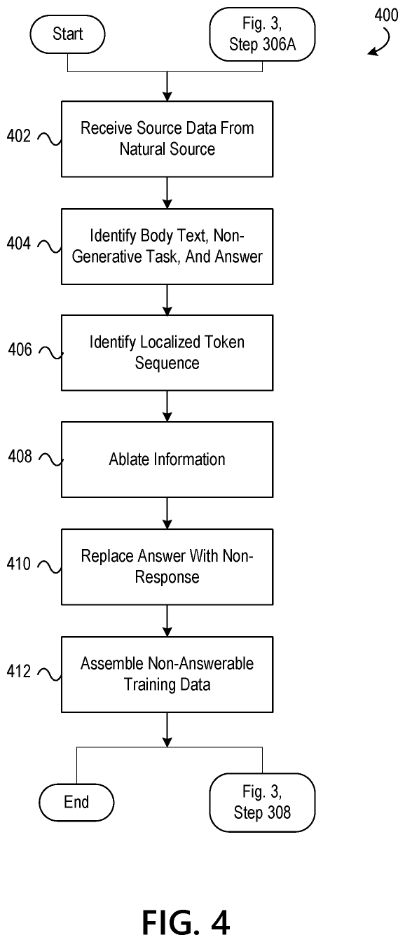

At step 306A, the computing device may generate augmented training data comprising non-answerable, non-generative data from a natural source according to method 400 as described herein with respect to FIG. 4. As described further herein with respect to FIG. 4, the computing device may receive source data from a natural source, identify body text, a non-generative task (e.g., question), and an answer, identify a localized token sequence corresponding to the answer in the body text, ablate the localized token sequence from the body text, replace the answer with a non-response, and/or assemble the non-answerable, non-generative training data. It should be understood that these are merely examples, and that other source data and combination of steps may be used, as described herein. The computing device may use various different source data, without departing from the scope of this disclosure. The steps may be performed in a different order without departing from the scope of this disclosure.

Additionally, or alternatively, the computing device may generate both answerable and non-answerable, non-generative training data from the natural source. In some embodiments, the answerable training data may retain the original body text and answer, while the non-answerable, non-generative training data may use the ablated body text and a non-response. It should be understood that the method for generating augmented training data from a natural source is not limited to the steps described in method 400 (FIG. 4), and that other methods for generating augmented training data from natural sources may be used without departing from the scope of this disclosure.

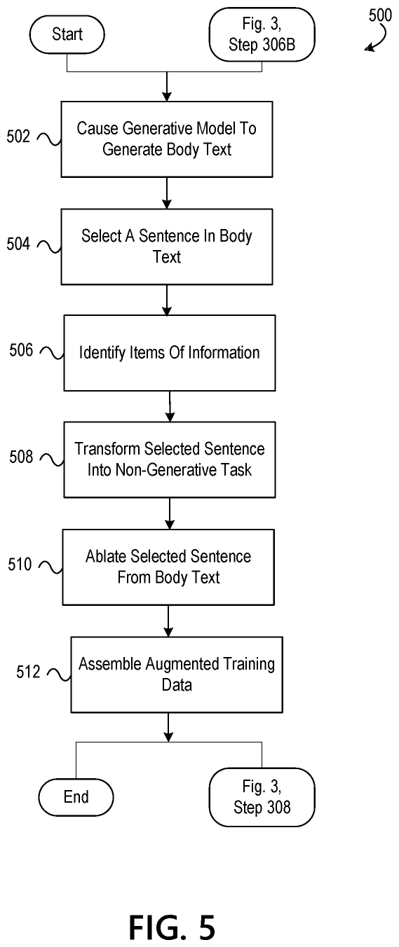

At step 306B, the computing device may generate augmented training data comprising non-answerable, non-generative data from a synthetic source according to method 500 as described herein with respect to FIG. 5. As described further herein with respect to FIG. 5, the computing device may cause a generative model to generate unablated body text, randomly select a sentence in the unablated body text, identify an item of information in the selected sentence, transform the selected sentence into a non-generative task (e.g., question), ablate the selected sentence from the body text, and/or assemble the augmented training data. It should be understood that these are merely examples, and that other source data and combination of steps may be used, as described herein. The computing device may use various different source data, without departing from the scope of this disclosure. The steps may be performed in a different order without departing from the scope of this disclosure.

Additionally, or alternatively, the computing device may generate both answerable and non-answerable training data from the synthetic source. In some embodiments, the computing device may control the ratio of answerable to non-answerable items to produce balanced training data. After either step 306A or step 306B, the computing device may continue to step 308, where the generative AI model may be configured using the augmented training data. It should be understood that the method for generating augmented training data from a synthetic source is not limited to the steps described in method 500 (FIG. 5), and that other methods for generating augmented training data from synthetic sources may be used without departing from the scope of this disclosure.

Additionally, or alternatively, in either or both of steps 306A/306B, the computing device may generate augmented training data that may, in some examples, augment, supplement, or replace training data used to train the generative artificial intelligence selected at step 302. The augmented training data may be or include data with a variety of tasks (e.g., questions). The data may be or include answerable tasks and/or non-answerable tasks. The augmented training data may further include indications (e.g., tags, stored correlations, or the like) of whether each task is answerable or non-answerable. Non-answerable, non-generative data may be generated by ablating, from body text of the source data, a localized token sequence corresponding to an answer to a task/question, and replacing the answer with a null response. The null response may comprise an indication that the answer is unknown, undefined, or not present in the body text. For example, if the source data includes a textbook chapter stating, “The first few primes are 2, 3, 5,” and a corresponding question, “What is the second prime number?” with the answer “3,” the computing device may ablate the sentence containing the answer from the body text and replace the answer with “Unknown” to create non-answerable, non-generative data for including in the augmented training data.

The non-answerable, non-generative data may comprise a token sequence including, in any order: the ablated body text; the non-generative task (e.g., question); the null response; and zero or more tokens to provide context for the previous constituents, such tokens serving as system instructions, to demarcate and/or name constituents, to disambiguate the non-generative task, or to serve other contextual purposes. For example, the assembled non-answerable, non-generative data item may be: “Prime numbers are whole numbers, other than 1, whose only factors in the whole numbers are 1 and the number itself. The number of primes is infinite. The density of primes less than or equal to a given number n decreases as n increases. According to the Prime Number Theorem, the density of primes less than or equal to n is asymptotic to 1/log(n). According to this text, what is the second prime number?Unknown.”

At step 308, the computing device may configure the generative artificial intelligence model for non-generative use. For example, the computing device may configure the generative artificial intelligence model using the augmented training data (e.g., as described herein at Section I(B): Preparation of Post-Training Data. In some examples, the configuring may comprise configuring the generative artificial intelligence model with the augmented training data at one or more training steps used in an iterative feedback loop for refining the generative artificial intelligence model. For example, the computing device may configure the generative artificial intelligence model during one or more of: a pre-training step, a post-training step, a fine-tuning step, a direct preference optimization step, a proximal policy optimization step, or a reinforcement learning step, with or without human feedback. For example, the computing device may configure the generative artificial intelligence model by providing the augmented training data as training data during a process of tuning the model (e.g., during an existing process of tagging or labeling answers provided by the generative artificial intelligence model), or the process of optimizing the model (e.g., during an existing process of identifying hyperparameters to improve the generative artificial intelligence model). It should be understood that these are merely examples and that the computing device may configure the generative artificial intelligence model using the augmented training data at any point in an existing process of training or retraining the generative artificial intelligence model. In some examples, the configuring of the generative artificial intelligence model may involve blending the augmented training data with existing training data. In some examples, the configuring of the generative artificial intelligence model may alternatively involve replacing existing training data with the augmented training data.

By configuring the generative artificial intelligence model using the augmented training data as described herein, the generative artificial intelligence model may be reconfigured, adjusted, augmented, or otherwise modified such that the generative artificial intelligence model, conventionally configured for probabilistic outputs based on probabilistic inputs, instead produces deterministic outputs based on probabilistic inputs. The resulting configured model may be a Non-Generative, Generative language model (i.e., a non-hallucinatory model) as described herein that may be probabilistic on input but deterministic on output.

Additionally, or alternatively, as shown in FIG. 3, method 300 may include a feedback loop from step 308 to step 304. After the generative artificial intelligence model is configured at step 308, the computing device may receive additional source data at step 304 and generate additional augmented training data at steps 306A and/or 306B to further configure the model. The post-training may occur at any point in the loop of using the model; that is, training data may be generated after the model is initially configured but may be applied to a step where the model is further configured, refined, updated, or otherwise trained, such as part of an iterative feedback loop. Additionally, or alternatively, the feedback loop may be repeated multiple times to iteratively improve the non-hallucinatory model. In some embodiments, the computing device may evaluate the performance of the configured model after each iteration and determine whether additional training data is needed. In other embodiments, the computing device may use different types of source data (e.g., natural source data in one iteration and synthetic source data in another iteration) across different iterations of the feedback loop. It should be understood that the feedback loop is merely illustrative, and that the computing device may configure the generative artificial intelligence model using a single pass through steps 304 through 308, or using any number of iterations, without departing from the scope of this disclosure.

At step 310, the computing device may receive input text and an indication of a non-generative task (e.g., question). In some examples, the computing device may receive the input text via user input to the computing device (e.g., via an input/output interface 119). In some examples, the computing device may receive the input text from another device (e.g., user device 200). The input text may be a document or text prompt that corresponds to the non-generative task. For example, the input text may be a book, datasheet, news article, or any other body of text. The non-generative task may be a question, prompt, or the like configured to elicit a bounded response derived from the input text, such as a numerical value, a name, a binary indicator (e.g., yes or no), a word, a phrase, or an exact quotation from the input text. For example, the input text may be a document, and the non-generative task may be a question asking for a specific piece of information from the document. It should be understood that this is merely an example, and that other input text and non-generative tasks may be used, as described herein. It should also be understood that the computing device may receive multiple input texts and non-generative tasks, without departing from the scope of this disclosure. For example, the computing device may identify all of the input text, and every non-generative task and answer included in the source data.

At step 312, the computing device may cause the non-hallucinatory model described herein to output a token sequence derived from the input text by processing the input text and the non-generative task. The processing may comprise encoding, based on probability weights of the generative artificial intelligence model, the input text and the non-generative task into one or more embeddings (e.g., vectors), and generating, without probabilistic extrapolation, an output token sequence derived from the input text. The probability weights may be used on the input side to comprehend the input prompt, but the output is generated deterministically without using probability weights in the output token generation process. In this way, the non-hallucinatory model remains probabilistic on input (i.e., the probability weights generated by and used in the underlying selected generative artificial intelligence model are not thrown out) but is deterministic on output because, as described at step 308, the non-hallucinatory model was configured to be deterministic on output based on the augmented training data. It should be understood that this is merely an example, and that the configured non-hallucinatory model may process the input text and the non-generative task using other methods, as described herein. It should also be understood that the encoding and generating steps described above are not limited to any particular implementation. For example, the probability weights may be used in other interpolative processes on the input side to comprehend the input prompt, and the output token sequence may be generated deterministically using other methods that do not rely on probabilistic extrapolation. It should also be understood that the one or more embeddings (e.g., vectors) are not limited to any particular dimensionality, representation, or neural network architecture, and may be produced by any suitable encoding process that uses the probability weights of the generative artificial intelligence model to comprehend the input text and the non-generative task.

At step 314, the computing device outputs a non-hallucinatory answer to the non-generative task. The non-hallucinatory answer may be or include the token sequence of step 312. Alternatively, in some examples, the non-hallucinatory answer may include the information in the token sequence reformatted for display (e.g., to a user). The answer is non-hallucinatory because the non-hallucinatory model that generated the token sequence was configured using the augmented training data such that the model is deterministic on output. The non-hallucinatory answer may comprise a bounded response derived from information present in the input text, or a null response indicating the information requested by the non-generative task is not present in the input text. For example, if the input text contains the answer to the non-generative task, the model outputs the answer; if the input text does not contain the answer, the model outputs “Unknown” rather than hallucinating an answer. In some examples, the computing device may output the non-hallucinatory answer by causing display of the non-hallucinatory answer. For example, the computing device may present the non-hallucinatory answer via a graphical user interface (GUI) or other interface (e.g., input/output interface 119). In some configurations, the computing device may cause display of the non-hallucinatory answer by sending the non-hallucinatory answer to a user device (e.g., user device 200) with one or more instructions or commands that, when executed, cause the user device to output the non-hallucinatory answer (e.g., on a display, or as audio). In some examples, the computing device may output the non-hallucinatory answer by sending the non-hallucinatory answer to the user device without causing the non-hallucinatory answer to be displayed. In some configurations, the computing device may output the non-hallucinatory answer by causing an actuator to perform some function or operation (e.g., a movement, a sound, or the like) that is responsive to the input non-generative task.

It should be understood that the steps described herein with respect to FIG. 3 are merely illustrative, and that the steps described with respect to FIG. 3 may be performed in a different order without departing from the scope of this disclosure. For example, the augmented training data may be generated before the generative artificial intelligence model is selected, or the computing device may receive the input text and the non-generative task before the configuring of the model is complete. Further, it should be understood that one or more additional or alternative steps may be performed to configure and apply a non-hallucinatory model without departing from the scope of this disclosure.

As described above with respect to step 306 of FIG. 3, the computing device may generate augmented training data comprising non-answerable, non-generative data. FIG. 4 illustrates an example method 400 for generating augmented training data comprising non-answerable, non-generative data from a natural source according to one or more embodiments. As shown in FIG. 4, the computing device may perform method 400 based on performing step 306A of method 300 (FIG. 3). The computing device performs method 400 to generate augmented training data comprising non-answerable, non-generative data from the natural source data. Additionally, or alternatively, the computing device may perform method 400 independently of method 300, or as part of a different workflow without departing from the scope of this disclosure. It should be understood that the connection from step 306A of FIG. 3 is merely illustrative, and that the computing device may receive source data from any suitable source and at any suitable point in the overall process.

Referring to FIG. 4, at step 402, a computing device (e.g., computational unit 103 as shown in FIG. 1) receives source data from a natural source. Natural sources may include textbooks, electronic documents, question-answer datasets, or observational data captured by one or more devices such as cameras, sensors, or the like. For example, the natural source may be a textbook having chapters with homework problems and an appendix with answers to the homework problems.

Additionally, or alternatively, the natural source may include frequently asked questions (FAQ) documents, reading comprehension tests, standardized test preparation materials, technical manuals with troubleshooting guides, legal documents with associated interrogatories, medical records with diagnostic questions, or any other source that contains body text paired with questions and corresponding answers. In some embodiments, the natural source may include multiple documents that are combined or processed together to form a single body text. In other embodiments, the natural source may be filtered or preprocessed to remove generative tasks (e.g., questions) that require lengthy answers such as essays, retaining only non-generative tasks (e.g., questions) with bounded answers.

At step 404, the computing device may identify body text, a non-generative task (e.g., question), and an answer in the source data. For example, using the textbook example, the computing device may identify a chapter on prime numbers as the body text, a homework question such as “What is the second prime number?” as the non-generative task, and “3” as the corresponding answer from the appendix. In some cases, the homework tasks (e.g., questions) in each chapter may mainly address information that is in the chapter itself but may also depend on preceding chapters or prerequisite materials. In such cases, reasonable additional previous context may need to be included in each training data item in order that the source of the extracted information is present in the body text. It should be understood that this is merely an example, and that other body text, non-generative tasks, and answers may be used, as described herein. It should also be understood that the computing device may identify multiple body texts, and multiple non-generative tasks and corresponding answers, without departing from the scope of this disclosure. For example, the computing device may identify all of the body text, and every non-generative task and answer included in the source data.

Additionally, or alternatively, the computing device may use natural language processing techniques to automatically identify the body text, non-generative task, and answer from unstructured source data. In some embodiments, the computing device may use pattern matching, regular expressions, or machine learning classifiers to distinguish between body text, questions, and answers. In other embodiments, the computing device may rely on structural elements of the source data, such as headings, numbering, or formatting, to identify the different components. In yet other embodiments, a human operator may provide annotations or labels to assist the computing device in identifying the body text, non-generative task, and answer.

At step 406, the computing device may identify a localized token sequence corresponding to the answer in the body text. In the simplest cases, the answer may literally present in the body text. For example, if the body text states, “The first few primes are 2, 3, 5” and the answer is “3,” the localized token sequence may be the sentence containing “2, 3, 5.” In medium-complexity cases, the extracted answer may exist in a localized sequence of tokens in the body text with essentially the same meaning but not necessarily using the same language. In the most complex cases, some non-generative tasks (e.g., questions) require answers that logically assemble multiple pieces of information that exist in the body text, either literally or with the same meaning required for the assembly. It should be understood that this is merely an example, and that other localized token sequence, body text, non-generative tasks, and answers may be used, as described herein. It should also be understood that the computing device may identify multiple token sequences, multiple body texts, and multiple non-generative tasks and corresponding answers, without departing from the scope of this disclosure. For example, the computing device may identify all of the token sequences, body texts, and every non-generative tasks and answers included in the source data.

Additionally, or alternatively, the computing device may use semantic similarity algorithms to identify the localized token sequence corresponding to the answer, even when the answer is paraphrased or expressed differently in the body text. In some embodiments, the computing device may use embedding vectors to compare the semantic similarity between the answer and portions of the body text. In other embodiments, the computing device may identify multiple localized token sequences that collectively correspond to the answer, particularly when the answer requires assembling information from multiple locations in the body text. In yet other embodiments, if the extracted answer could be assembled from both explicitly stated source information in the body text and also implicitly by means of operations beyond the abilities of a language model (e.g., mathematical calculations or inductive logic), the computing device may identify only the explicit source information for ablation.

At step 408, the computing device may ablate information from the body text. The computing device may ablate one or more items of information from the body text that comprise elements of the body text, where those elements collectively comprise an answer (e.g., to a task/question). The computing device may ablate the items of information by removing the one or more items of information from the body text and replacing the answer (e.g., by replacing the one or more items of information) with a null response. The null response may comprise an indication that the answer is unknown, undefined, or not present in the body text.

As an illustrative example, the computing device may ablate the localized token sequence from the body text. To make the automated ablation of the source information for an extracted answer as reliable as possible, one embodiment of the method may be to ablate only complete sentences from the body text. For example, for the non-generative task, “According to this text, what is the second prime number?” ablating only the extracted answer itself, “3,” would result in the incoherent, ablated body text “ . . . The first few primes are 2, 5 . . . ,” for which the now apparently “correct” answer, based on this ablated body text, would not be a non-response, as intended, but instead, “5.” By ablating complete sentences only, the ablated body text would become “ . . . number itself. The number . . . ”, for which the correct answer to the non-generative task (e.g., question) is now a non-response, such as “Unknown,” as intended. It should be understood that this is merely an example, and that other token sequence, body text, non-generative tasks, and answers may be used, as described herein. It should also be understood that the computing device may identify multiple token sequences, body texts, and multiple non-generative tasks and corresponding answers, without departing from the scope of this disclosure. For example, the computing device may identify all of the token sequences, body texts, and every non-generative tasks and answers included in the source data.

Additionally, or alternatively, the computing device may ablate paragraphs, sections, or other logical units of text rather than individual sentences. In some embodiments, the computing device may use more sophisticated ablation algorithms that remove only the minimal amount of text necessary to make the task (e.g., question) unanswerable while preserving the coherence of the remaining body text. In other embodiments, if multiple pieces of information are required to assemble the extracted answer, the computing device may ablate only one of the required pieces of information, which is sufficient to create unanswerable, non-generative training data. In yet other embodiments, the computing device may filter out tasks (e.g., questions) that require operations beyond the abilities of the underlying generative language model, such as mathematical calculations or inductive logic, rather than attempting to ablate them.

At step 410, the computing device may replace the answer with a suitable non-response. For example, the computing device may replace the answer, in the body text, with a null response. The null response may comprise an indication that the answer is unknown, undefined, or not present in the body text. For example, the answer “3” may be replaced with “Unknown.” It should be understood that this is merely an example, and that other answers and suitable non-responses may be used, as described herein. It should also be understood that the computing device may replace multiple answers and suitable non-responses, without departing from the scope of this disclosure. For example, the computing device may replace all of the answers included in the source data and replace with another suitable non-response.

Additionally, or alternatively, the non-response (e.g., null response) may comprise other indicators such as “N/A,” “Not found,” “Cannot be determined from the text,” “Insufficient information,” or any other suitable indication that distinguishes the null response from an ordinary response to the non-generative task. In some embodiments, the null response may be selected from a predefined set of null response options to provide variety in the training data. In other embodiments, the null response may include an explanation or reason for why the answer cannot be determined from the body text. In yet other embodiments, the computing device may generate both answerable and unanswerable training data items from the same source data, with the answerable items retaining the original answer and the unanswerable items using the null response, to provide balanced training data across different classes. By performing the functions of step 410 to replace an answer with non-generative, unanswerable data, the computing device is configured to assemble non-answerable, non-generative data (e.g., as described at step 412) to include in augmented training data used to configure a non-hallucinatory model to respond with a null response when the information requested by the non-generative task is not present in the input text, rather than hallucinating an answer.

At step 412, the computing device may assemble the non-answerable, non-generative data. When assembling non-answerable, non-generative data from a natural source, the computing device may combine the already-ablated body text as described herein with respect to step 408 with the original non-generative task (e.g., question) from the natural source and a null response replacing the original answer. In some examples, the assembled non-answerable, non-generative data may comprise one or more items of non-generative data as described herein with respect to step 306 of FIG. 3. Because the non-generative task (e.g., question) already exists in the natural source data, the assembly step pairs the ablated body text with the original task and replaces the original answer with a null response.

Additionally, or alternatively, the non-answerable, non-generative data may be assembled in various token sequence formats known to those of ordinary skill in the art of preparation of training data for generative models. In some embodiments, the token sequence may include explicit labels or demarcations, such as “Document:”, “Question:”, and “Answer:” to clearly delineate the different components. In other embodiments, the token sequence may include system instructions such as “Please read the following Document and answer the question at the end” to provide context for the non-generative task. In yet other embodiments, the computing device may generate multiple variations of the assembled non-answerable, non-generative data using different token sequence formats to increase the diversity of the training data.

Additionally, or alternatively, the augmented training data may also include answerable, non-generative training data alongside the unanswerable data. Post-training methods as described herein perform best/most optimally with training data that is somewhat balanced across different classes. For this reason, it may be beneficial to additionally augment the training data with answerable, non-generative data, if it is not already present. In some embodiments, the computing device may generate both answerable and unanswerable training data items from the same natural source, with the answerable items retaining the original body text and answer, and the unanswerable items using the ablated body text and a null response.

Upon completion of step 412, the computing device may proceed to step 308 of method 300 (FIG. 3), where the generative artificial intelligence model is configured for non-generative use using the augmented training data assembled at step 412. As described with respect to FIG. 3, the configuring at step 308 may comprise applying the augmented training data to one or more of a pre-training step, a post-training step, a fine-tuning step, or a reinforcement learning step. Additionally, or alternatively, as indicated by the feedback loop shown in FIG. 3, the post-training may also occur at any point in the loop of using the model; that is, training data may be generated after the model is initially trained but may be applied to a step where the model is further configured, refined, updated, or otherwise trained, such as part of an iterative feedback loop. In some embodiments, after the computing device has configured the generative artificial intelligence model at step 308, the computing device may return to step 304 to receive additional source data, and the computing device may perform method 400 again via step 306A to generate additional augmented training data for further configuring the model. It should be understood that the connection to step 308 of FIG. 3 is merely illustrative, and that the computing device may use the augmented training data assembled at step 412 at any suitable point in the overall process without departing from the scope of this disclosure.

It should be understood that the steps described herein with respect to FIG. 4 are merely illustrative, and that the steps described with respect to FIG. 4 may be performed in a different order without departing from the scope of this disclosure. For example, the computing device may identify the localized token sequence corresponding to the answer before identifying the body text, non-generative task, and answer as separate components, or the computing device may replace the answer with a null response before ablating the localized token sequence from the body text. Further, it should be understood that one or more additional or alternative steps may be performed to generate augmented training data comprising non-answerable, non-generative data from a natural source without departing from the scope of this disclosure.

FIG. 5 illustrates a method 500 for generating augmented training data comprising non-answerable, non-generative data from a synthetic source according to one or more embodiments. As shown in FIG. 5, the computing device may perform method 500 as part of step 306B of method 300 (FIG. 3). After the computing device has selected the generative artificial intelligence model at step 302, received source data at step 304, and determined that the source data is from a synthetic source at decision 305, the computing device may proceed to step 306B, which corresponds to method 500. The computing device performs method 500 to generate augmented training data comprising non-answerable, non-generative data from the synthetic source. Additionally, or alternatively, the computing device may perform method 500 independently of method 300, or as part of a different workflow without departing from the scope of this disclosure. It should be understood that the connection from step 302 of FIG. 3 is merely illustrative, and that the computing device may generate synthetic source data at any suitable point in the overall process.

At step 502, a computing device (e.g., computational unit 103 as shown in FIG. 1) may cause a generative model to generate body text (e.g., unablated body text). The generative model may be an existing second-generation generative artificial intelligence model that is used to randomly generate body text, possibly seeded with selected prompts. In some examples, the generative model may be the generative model selected by the computing device as the base model for a non-hallucinatory model (e.g., as described at step 302). In some examples, the generative model may alternatively be a different model (e.g., a commercial off-the-shelf (COTS)) model selected specifically for use in generating synthetic source data). The generative model may be prompted to generate text about a particular subject matter, such as science, history, business, or any other domain. It should be understood that this is merely an example, and that other generative models, subject matter, and prompts may be used, as described herein. It should also be understood that the computing device may use multiple generative models, multiple subject matters, and multiple prompts, without departing from the scope of this disclosure.

Additionally, or alternatively, the generative model may be prompted with specific parameters to control the length, complexity, or style of the generated body text. In some embodiments, the generative model may generate body text that mimics the structure and format of natural sources, such as textbook chapters, news articles, or technical documents. In other embodiments, the computing device may generate multiple variations of body text on the same topic to increase the diversity of the training data. In yet other embodiments, metadata about the generated text may be retained, allowing the identification of meaningful elements of the text, such as subjects, objects, verbs, or other elements.

The computing device may, based on generating the body text (e.g., by causing the generative model to generate the body text, select (e.g., using random selection) an item or combination of items of information in the body text that provide a correct answer to a non-generative text as the synthetic source data (e.g., as described herein with respect to step 504). The computing device may additionally or alternatively, based on generating the body text (e.g., by causing the generative model to generate the body text, determine that no item of information or combination of items of information in the body text provides a correct answer to a non-generative task.

At step 504, the computing device may select a sentence in the unablated body text. The computing device may randomly select the sentence. The selected sentence contains information that will be used to create a non-generative task (e.g., question) and corresponding answer. For example, if the generated body text includes the sentence “The company was founded in 1995 by John Smith,” this sentence may be randomly selected for further processing. It should be understood that this is merely an example, and that other sentences in the unablated body text may be selected, as described herein. It should also be understood that the computing device may select sentences using methods other than random selection without departing from the scope of this disclosure. For example, the computing device may use weighted selections to prioritize sentences containing factual information, named entities, or numerical values, or may select multiple sentences from the same body text to generate multiple items of non-answerable, non-generative data. Additionally, or alternatively, the computing device may use weighted random selection to prioritize sentences that contain factual information, named entities, numerical values, or other elements that are well-suited for non-generative tasks (e.g., questions). In some embodiments, the computing device may select multiple sentences from the same body text to generate multiple training data items. In other embodiments, the computing device may filter out sentences that are too short, too complex, or otherwise unsuitable for creating non-generative tasks (e.g., questions).

At step 506, the computing device may identify an item of information, or combination of items of information, in the body text. The item or combination of items of information may be a named entity, a numerical value, a date, a location, or any other piece of information that may serve as an answer to a non-generative task (e.g., question). In some examples, the computing device may identify items of information in the sentence selected at step 504. In some examples, the computing device may identify items of information in any sentences or other portions of the body text. For example, from the sentence “The company was founded in 1995 by John Smith,” the computing device may identify “1995” as the item of information. It should be understood that this is merely an example, and that other items of information in the selected sentence may be identified, as described herein. It should also be understood that the computing device may identify multiple items of information in the same selected sentence without departing from the scope of this disclosure. For example, from the sentence “The company was founded in 1995 by John Smith,” the computing device may identify “1995,” “John Smith,” or both as items of information, and may generate separate items of non-answerable, non-generative data for each identified item of information.

Additionally, or alternatively, the computing device may identify multiple items of information in the selected sentence and create separate training data items for each. In some embodiments, the computing device may use named entity recognition, part-of-speech tagging, or other natural language processing techniques to identify items of information. In other embodiments, the computing device may prioritize certain types of information, such as proper nouns or numerical values, that are more likely to yield clear and unambiguous non-generative tasks (e.g., questions).

At step 508, the computing device may transform the selected sentence into a non-generative task (e.g., question), wherein the identified item of information corresponds to the answer. For example, the sentence “The company was founded in 1995 by John Smith” may be transformed into the question “In what year was the company founded?” with the answer being “1995.” It should be understood that this is merely an example, and that other transformations of the selected sentence into a non-generative task (e.g., question) may be used, as described herein. It should also be understood that the computing device may generate multiple non-generative tasks (e.g., questions) from the same selected sentence without departing from the scope of this disclosure.

Additionally, or alternatively, the computing device may generate multiple non-generative tasks (e.g., questions) from the same sentence by targeting different items of information. In some embodiments, the computing device may use template-based question generation, where predefined templates are filled in with information from the sentence. In other embodiments, the computing device may use a generative model to create more natural and varied question phrasings. In yet other embodiments, the non-generative task may take forms other than questions, such as fill-in-the-blank tasks, true/false statements, or extraction commands.

At step 510, the computing device may ablate the selected sentence from the body text. By removing the sentence that contains the answer, the non-generative task (e.g., question) becomes unanswerable based on the remaining body text. For example, after ablating the sentence “The company was founded in 1995 by John Smith,” the question “In what year was the company founded?” cannot be answered from the remaining body text. It should be understood that this is merely an example, and that other sentences or portions of the body text may be ablated, as described herein. It should also be understood that the computing device may ablate the selected sentence using methods other than full sentence removal without departing from the scope of this disclosure. For example, the computing device may ablate only a portion of the selected sentence, ablate multiple sentences, or ablate paragraphs or other logical units of text, provided that the ablation is sufficient to make the non-generative task (e.g., question) unanswerable based on the remaining body text.

Additionally, or alternatively, the computing device may ablate only a portion of the selected sentence rather than the entire sentence, provided that the ablation is sufficient to make the task (e.g., question) unanswerable. In some embodiments, the computing device may ablate additional sentences that contain related information to ensure the task (e.g., question) is truly unanswerable. In other embodiments, the computing device may verify that the ablated body text remains coherent and grammatically correct after the ablation. By performing the functions of step 510 to ablate the selected sentence from the body text, the computing device is configured to assemble non-answerable, non-generative data (e.g., as described at step 512) to include in augmented training data used to configure a non-hallucinatory model to respond with a null response when the information requested by the non-generative task is not present in the input text, rather than hallucinating an answer.

At step 512, the computing device may assemble the non-answerable, non-generative data. The non-answerable, non-generative data may comprise a token sequence including: the ablated body text (with the selected sentence removed); the non-generative task (e.g., question) constructed from the selected sentence; and a null response indicating that the answer is unknown or not present in the body text. When assembling non-answerable, non-generative data from a synthetic source, the assembly process may differ from the natural source assembly in that all components (e.g., the body text, the non-generative task, and the determination of answerability) are synthetically generated rather than derived from existing materials. For each item of training data, an existing generative model may be used to randomly generate body text. If sufficient metadata about the generated text is retained, allowing the identification of meaningful elements of the text, such as subjects, objects, verbs, or other elements, then corresponding non-generative tasks (e.g., questions) of various types and of varying complexity may also be randomly generated, which can be logically determined to be either answerable or unanswerable from the generated text. Finally, the synthetic item of answerable or unanswerable, non-generative training data may be assembled as a sequence comprising of (1) the generated body text, (2) the generated non-generative task (e.g., question) logically constructed to be either answerable or unanswerable, and (3) a suitable response or non-response. In some examples, the assembled non-answerable, non-generative data may comprise one or more items of non-generative data as described at step 306 of FIG. 3.

Additionally, or alternatively, unlike the natural source assembly where answerability is determined by whether the answer has been ablated from existing text, the synthetic source assembly may determine answerability logically based on the relationship between the synthetically generated task (e.g., question) and the synthetically generated body text. Additionally, or alternatively, the computing device may assemble both answerable and unanswerable training data items from the same synthetic source. In some embodiments, the answerable training data item may include the unablated body text, the non-generative task (e.g., question), and the correct answer, while the unanswerable training data item may include the ablated body text, the same non-generative task (e.g., question), and a null response. In other embodiments, the computing device may generate training data items with varying degrees of difficulty by controlling the complexity of the non-generative tasks (e.g., questions) or the amount of text ablated. In yet other embodiments, the assembled non-answerable, non-generative data may include context tokens such as system instructions, demarcators, or other elements to provide structure to the training data. In other embodiments, the computing device may control the ratio of answerable to unanswerable items to produce balanced training data. It should be understood that the above methods of implementing the present disclosure are merely exemplary and that other methods for automatically producing the answerable and/or unanswerable, non-generative training data as described herein may be used without departing from the present disclosure.

Upon completion of step 512, the computing device may proceed to step 308 of method 300 (FIG. 3), where the computing device configures the generative artificial intelligence model for non-generative use using the augmented training data assembled at step 512. As described with respect to FIG. 3, the computing device may configure the generative artificial intelligence model by applying the augmented training data to one or more of a pre-training step, a post-training step, a fine-tuning step, or a reinforcement learning step. Additionally, or alternatively, as indicated by the feedback loop shown in FIG. 3, the post-training may also occur at any point in the loop of using the model; that is, training data may be generated after the model is initially trained but may be applied to a step where the model is further configured, refined, updated, or otherwise trained, such as part of an iterative feedback loop. In some embodiments, after the computing device has configured the generative artificial intelligence model at step 308, the computing device may return to step 304 to receive additional source data, and the computing device may perform method 500 again via step 306B to generate additional augmented training data from synthetic sources for further configuring the model. It should be understood that the connection to step 308 of FIG. 3 is merely illustrative, and that the computing device may use the augmented training data assembled at step 512 at any suitable point in the overall process without departing from the scope of this disclosure.

It should be understood that the steps described herein with respect to FIG. 5 are merely illustrative, and that the steps described with respect to FIG. 5 may be performed in a different order without departing from the scope of this disclosure. For example, the computing device may identify the item of information in the selected sentence before randomly selecting the sentence, or the computing device may ablate the selected sentence from the body text before transforming the selected sentence into a non-generative task. Further, it should be understood that one or more additional or alternative steps may be performed to generate augmented training data comprising non-answerable, non-generative data from a synthetic source without departing from the scope of this disclosure.

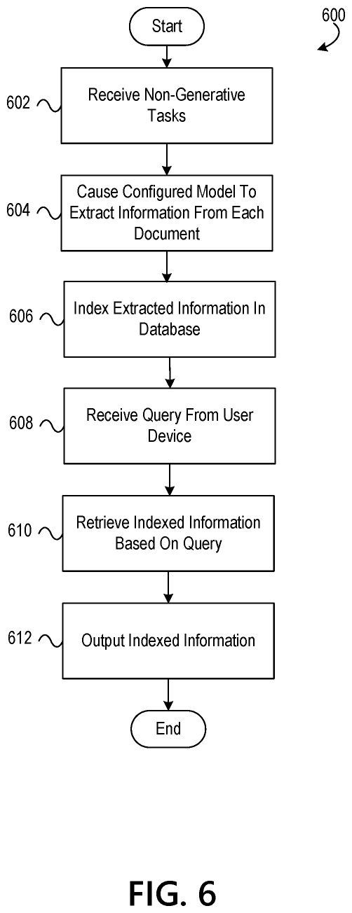

As described above with respect to FIGS. 4 and 5, the computing device may generate augmented training data comprising non-answerable, non-generative data from natural or synthetic sources. This augmented training data is used to configure the generative artificial intelligence model for non-generative use, as described with respect to step 308 of FIG. 3. Once configured, the non-hallucinatory model may be applied to various enterprise applications. FIG. 6 illustrates an example method 600 for a search and indexing application using a configured non-hallucinatory model according to one or more embodiments.

At step 602, a computing device (e.g., computational unit 103 as shown in FIG. 1) may receive one or more non-generative tasks (e.g., questions) to be applied to a plurality of documents in a database. In some examples, the computing device may receive the one or more non-generative tasks (e.g., questions) via user input to the computing device (e.g., via an input/output interface 119). In some examples, the computing device may receive the one or more non-generative tasks (e.g., questions) from another device (e.g., user device 200). The non-generative tasks may be defined by a domain expert who specifies the relevant information that should be extracted from the documents. For example, if the documents are sales invoices, a product manager may define non-generative tasks such as: “What is the product name?”, “What is the customer segment?”, “What is the sale amount?”, and “What is the geographic region?” It should be understood that these are merely examples, and that other non-generative tasks (e.g., questions) may be defined and applied to other types of documents, as described herein. It should also be understood that the computing device may receive the one or more non-generative tasks from any suitable source without departing from the scope of this disclosure. For example, the non-generative tasks may be received from a domain expert, a user device, an automated system, a predefined configuration, or any combination thereof. It should also be understood that the documents in the database are not limited to sales invoices, and may include any type of unstructured or structured documents, such as legal contracts, medical records, financial reports, business plans, emails, or any other documents containing information that may be extracted using the non-hallucinatory model as described herein.

Additionally, or alternatively, the non-generative tasks may be received from a user device, an automated system, or a predefined configuration. In some embodiments, the non-generative tasks may be defined using natural language, so long as the specification of each task takes the form of a non-generative task (e.g., question) that can be answered with a bounded response. In other embodiments, the non-generative tasks may include dependencies, where the specification of tasks later in the list can depend on the value of items already extracted earlier in the list. In yet other embodiments, the computing device may receive a template or schema that defines the structure of the information to be extracted from the documents.

At step 604, the computing device may cause the configured non-hallucinatory model described herein to extract information responsive to the one or more non-generative tasks from each document of the plurality of documents. For each document, the configured model processes the document text and the non-generative tasks, and outputs either a bounded response derived from the document or a null response indicating the information is not present in the document.

Additionally, or alternatively, the computing device may process the documents in parallel to improve throughput. In some embodiments, the computing device may prioritize certain documents based on recency, relevance, or other criteria. In other embodiments, the computing device may cache or store intermediate results to avoid redundant processing. In yet other embodiments, if the configured model outputs a null response for a particular non-generative task, the computing device may flag the document for human review or further processing.

At step 606, the computing device may index the extracted information in the database to be available for future search. The extracted information may be stored in a relational database, keyed to the type of information extracted and the source document. For example, the extracted product names, customer segments, sale amounts, and geographic regions from the sales invoices may be stored in a structured database with appropriate indices. It should be understood that this is merely an example, and that other types of extracted information may be indexed in other types of databases, as described herein. It should also be understood that the computing device may index the extracted information using methods other than those specifically described without departing from the scope of this disclosure. For example, the computing device may store the extracted information in a relational database, a document database, a graph database, or any other suitable data storage system, and may create multiple indices to support different types of queries or different end user workflows.

Additionally, or alternatively, the computing device may store the extracted information in a document database, a graph database, or any other suitable data storage system. In some embodiments, the computing device may create multiple indices to support different types of queries. In other embodiments, the computing device may update the database schema to accommodate new types of information as they are defined by domain experts. In yet other embodiments, if circumstances change and some new piece of information is deemed relevant by domain experts, the configured model may be used to extract just this new information, amend the database schema to include it, and reindex the records of the documents in the database.

At step 608, the computing device may receive a query from a user device (e.g., user device 107,109, or 200 as shown in FIG. 1). In some examples, the computing device may receive the query via user input to the computing device (e.g., via an input/output interface 119). In some examples, the computing device may receive the query from another device (e.g., user device 200). The query may be a search request from an end user who is looking for specific information from the indexed documents. For example, a product manager may query for “all sales in the Northeast region for Product X.” It should be understood that this is merely an example, and that other types of queries may be received from other types of devices, as described herein. It should also be understood that the computing device may receive the query through any suitable communication channel without departing from the scope of this disclosure. For example, the query may be received from a user device via a web browser, a software application, an API call, an automated system, a scheduled job, or any other suitable interface. It should also be understood that the query is not limited to product sales information, and may include any type of search request for information that has been indexed in the database using the configured non-hallucinatory model as described herein.

Additionally, or alternatively, the query may be received from an automated system, a scheduled job, or an API call. In some embodiments, the query may be expressed in natural language and parsed by the computing device to identify the relevant indexed information. In other embodiments, the query may be expressed in a structured query language such as SQL. In yet other embodiments, the computing device may support complex queries that combine multiple criteria or aggregate information across multiple documents.

At step 610, the computing device may retrieve the indexed information based on the query. In some examples, the computing device may retrieve the indexed information via user input to the computing device (e.g., via an input/output interface 119). In some examples, the computing device may retrieve the indexed information from another device (e.g., user device 200). The computing device searches the indexed database for information that matches the query criteria and returns the relevant results. For example, the computing device may return all indexed records where the geographic region is “Northeast,” and the product name is “Product X.” It should be understood that this is merely an example, and that other types of indexed information may be retrieved based on other types of queries, as described herein. It should also be understood that the computing device may retrieve the indexed information using methods other than those specifically described without departing from the scope of this disclosure. For example, the computing device may retrieve the indexed information using structured query language, natural language queries, keyword searches, or any combination thereof. The computing device may also rank the retrieved results by relevance, recency, or other criteria, or may apply filters, aggregations, or transformations to the retrieved information before returning it to the user.

Additionally, or alternatively, the computing device may rank the retrieved results by relevance, recency, or other criteria. In some embodiments, the computing device may return not only the extracted information but also references to the source documents from which the information was extracted. In other embodiments, the computing device may apply filters, aggregations, transformations, or the like to the retrieved information before returning it to the user.

At step 612, the computing device output indexed information. For example, the computing device may cause the non-hallucinatory model described herein to output the indexed information. For example, outputting indexed information may involve including the retrieved information in an end user workflow. In some examples, the computing device may output the indexed information by causing display of the indexed information. For example, the computing device may present the indexed information via a graphical user interface (GUI) or other interface (e.g., input/output interface 119). In some configurations, the computing device may cause display of the indexed information by sending the indexed information to a user device (e.g., user device 200) with one or more instructions or commands that, when executed, cause the user device to output the indexed information (e.g., on a display, or as audio). In some examples, the computing device may output the indexed information by sending the indexed information to the user device without causing the indexed information to be displayed. In some configurations, the computing device may output the indexed information by causing an actuator to perform some function or operation (e.g., a movement, a sound, or the like) that is responsive to the input non-generative task.

In some examples, the retrieved information may be delivered to the end user through a business analytics tool, a dashboard, a report, or any other suitable interface. For example, the product manager may receive the retrieved sales information in a business analytics front-end tool that enables them to better understand the historical trends of product success or failure. In some examples, the computing device may send the retrieved information to another device (e.g., user device 200) via an input/output interface (e.g., input/output interface 119).

Additionally, or alternatively, the retrieved information may be integrated into other enterprise workflows, such as customer relationship management systems, financial reporting systems, or supply chain management systems. In some embodiments, the computing device may format the retrieved information according to a predefined template before delivering it to the end user. In other embodiments, the computing device may trigger automated actions based on the retrieved information, such as sending alerts or notifications. In yet other embodiments, the retrieved information may be reassembled or combined with other data sources to produce comprehensive reports or analyses. It should be understood that these are merely examples, and that the retrieved information may be delivered to other systems and in other formats, as described herein.

It should be understood that the steps described herein with respect to FIG. 6 are merely illustrative, and that the steps described with respect to FIG. 6 may be performed in a different order without departing from the scope of this disclosure. For example, the computing device may index the extracted information as it is extracted from each document rather than after all documents have been processed, or the computing device may receive the query from the user device before all documents in the database have been processed. Further, it should be understood that one or more additional or alternative steps may be performed to implement a search and indexing application using a configured non-hallucinatory model without departing from the scope of this disclosure.

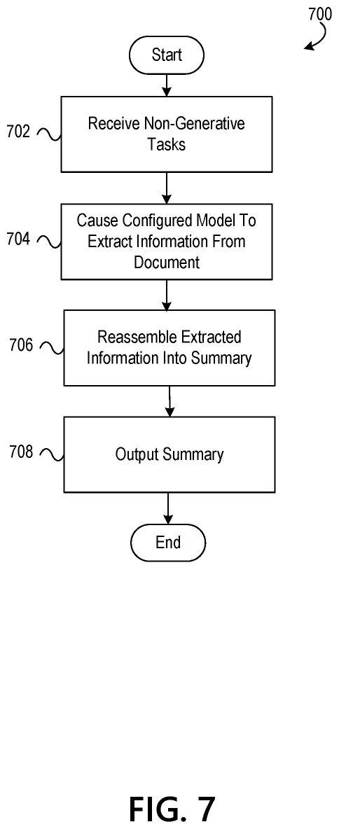

As described above with respect to FIG. 6, the configured non-hallucinatory model may be applied to various enterprise applications. While FIG. 6 illustrates a search and indexing application, FIG. 7 illustrates a method 700 for a summarization application using a configured non-hallucinatory model according to one or more embodiments.

At step 702, a computing device (e.g., computational unit 103 as shown in FIG. 1) may receive one or more non-generative tasks (e.g., questions) to be applied to a document. In some examples, the computing device may receive the one or more non-generative tasks (e.g., questions) via user input to the computing device (e.g., via an input/output interface 119). In some examples, the computing device may receive the one or more non-generative tasks (e.g., questions) from another device (e.g., user device 200). The non-generative tasks may be defined by a domain expert who specifies the relevant information that should be extracted from the document for summarization purposes. For example, if the document is a startup business plan and the end users are potential venture capital investors, the domain expert may define non-generative tasks to extract information such as the product, addressable market, go-to-market strategy, revenue projections, use of funds, and capitalization table. It should be understood that these are merely examples, and that other non-generative tasks (e.g., questions) may be defined and applied to other types of documents for summarization purposes, as described herein. It should also be understood that the computing device may receive the one or more non-generative tasks from any suitable source without departing from the scope of this disclosure. For example, the non-generative tasks may be received from a domain expert, a user device, a predefined template, an automated system, or any combination thereof. It should also be understood that the documents are not limited to startup business plans, and may include any type of document containing unstructured information that may be summarized using the non-hallucinatory model as described herein, such as analyst reports, legal contracts, medical records, financial reports, or any other documents for which a concise and relevant summary would be valuable to an end user.

Additionally, or alternatively, the non-generative tasks may be tailored to the specific needs of the intended end user. In some embodiments, different sets of non-generative tasks may be defined for different audiences. For example, potential cofounders may be interested in different information about a business plan than venture capital investors. In other embodiments, the non-generative tasks may be organized hierarchically, where complex information is broken down into multiple sub-tasks. For example, “use of funds” may consist of a plurality of tasks regarding the allocation of funds to specific business expenses. In yet other embodiments, the computing device may receive the non-generative tasks from a user device, a predefined template, or an automated system.

At step 704, the computing device may cause the non-hallucinatory model described herein to extract information responsive to the one or more non-generative tasks from the document. For each non-generative task, the configured model may process the document text and the task, and may output either a bounded response derived from the document or a null response indicating the information is not present in the document. It should be understood that this is merely an example, and that the configured non-hallucinatory model may extract information responsive to other types of non-generative tasks (e.g., questions) from other types of documents, as described herein. It should also be understood that the computing device may cause the configured non-hallucinatory model to process the document using methods other than those specifically described without departing from the scope of this disclosure. For example, the computing device may process the non-generative tasks sequentially, in parallel, or in a specific order where later tasks depend on the results of earlier tasks. It should also be understood that the document is not limited to any particular type, and may include any document containing unstructured information from which bounded responses may be extracted using the non-hallucinatory model as described herein.

Additionally, or alternatively, the computing device may process the non-generative tasks in a specific order, particularly when later tasks depend on the results of earlier tasks. In some embodiments, the computing device may validate the extracted information against predefined criteria or constraints. In other embodiments, if the configured model outputs a null response for a particular non-generative task, the computing device may indicate in the summary that the information was not found in the document. In yet other embodiments, the computing device may extract additional contextual information to support or clarify the primary extracted information.

At step 706, the computing device may reassemble the extracted information into a summary. The extracted information from the various non-generative tasks is combined and formatted into a concise and relevant summary for the intended end user. For example, the extracted product, addressable market, go-to-market strategy, revenue projections, use of funds, and capitalization table information may be assembled into a well-formatted summary designed by and for experts in venture capital. It should be understood that this is merely an example, and that other types of extracted information may be reassembled into other types of summaries for other types of end users, as described herein. It should also be understood that the computing device may reassemble the extracted information using methods other than those specifically described without departing from the scope of this disclosure. For example, the computing device may reassemble the extracted information using a predefined template, a dynamically generated format, or any other suitable method for combining the extracted information into a concise and relevant summary. It should also be understood that the summary is not limited to startup business plan information, and may include any type of extracted information that has been obtained using the configured non-hallucinatory model as described herein.

Additionally, or alternatively, the summary may be formatted according to a predefined template that specifies the structure and presentation of the extracted information. In some embodiments, the template may be specified in a variety of standard formats, such as Markdown, HTML, or plain text. In other embodiments, the computing device may apply additional formatting, such as headings, bullet points, or tables, to improve the readability of the summary. In yet other embodiments, the computing device may include only the extracted information that is present in the document, omitting sections where the configured model returned a null response.

At step 708, the computing device may cause the non-hallucinatory model described herein to output the summary. For example, outputting the summary may involve providing the summary to an end user workflow. The summary may be delivered to the end user through email, a document management system, a collaboration platform, or any other suitable interface. For example, the venture capital investor may receive the formatted summary of the business plan in a timely manner, enabling them to quickly assess the key information without reading the entire document. In some examples, the computing device may output the summary by causing display of the summary. For example, the computing device may present the summary via a graphical user interface (GUI) or other interface (e.g., input/output interface 119). In some configurations, the computing device may cause display of the summary by sending the summary to a user device (e.g., user device 200) with one or more instructions or commands that, when executed, cause the user device to output the summary (e.g., on a display, or as audio). In some examples, the computing device may output the summary by sending the summary to the user device without causing the summary to be displayed. In some configurations, the computing device may output the summary by causing an actuator to perform some function or operation (e.g., a movement, a sound, or the like) that is responsive to the input non-generative task.

Additionally, or alternatively, the summary may be stored in a database for future reference or comparison. In some embodiments, the computing device may deliver the summary to multiple end users or distribution lists. In other embodiments, the computing device may trigger automated actions based on the content of the summary, such as scheduling follow-up meetings or flagging documents for further review. In yet other embodiments, the summary may be integrated into a larger workflow that combines summaries from multiple documents to produce comprehensive reports or analyses. In some examples, the computing device may send the summary to another device (e.g., user device 200) via an input/output interface (e.g., input/output interface 119).

It should be understood that the steps described herein with respect to FIG. 7 are merely illustrative, and that the steps described with respect to FIG. 7 may be performed in a different order without departing from the scope of this disclosure. For example, the computing device may reassemble portions of the extracted information into a partial summary as each non-generative task is processed rather than after all tasks have been completed, or the computing device may provide the summary to the end user workflow incrementally as information is extracted. Further, it should be understood that one or more additional or alternative steps may be performed to implement a summarization application using a configured non-hallucinatory model without departing from the scope of this disclosure.

### III. Illustrative Use Case Scenario

### A. Illustrative Implementation

The components of the described methods for producing a Non-Generative, Generative artificial intelligence model (i.e., a non-hallucinatory model) will now be explained in a number of illustrative example embodiments.

A first illustrative embodiment for automatically producing the answerable and/or unanswerable, non-generative training data, from natural sources, will be here further illustrated with a concrete implementation.

To automatically create a sufficient scale of answerable and/or unanswerable, non-generative training data is an engineering balance between the amount and suitability of naturally sourced non-generative training data available, and the complexity of the automated non-generative ablation algorithm that needs to be deployed for preparing the unanswerable training examples.

To provide fulsome implementation guidance for those of ordinary skill in the art, this illustrative implementation will demonstrate the complexities that may be encountered with sophisticated extractions, and how the balance between filtering out unsuitable naturally sourced non-generative data items, versus deploying a more complex ablation algorithm, may be best achieved.

To process source data (e.g., data from natural sources, such as observational data captured by devices such as cameras, sensors, or the like, and/or text data such as electronic documents, textbooks, or the like), the source data may be provided to a central processing unit (CPU) or other computational unit, such as computational unit 103 as described herein. Consider for example, the following hypothetical textbook, as a natural source, in the mathematical domain, that might be provided to computational unit 103 for processing. The textbook may have chapters with homework problems, and an appendix at the end, with answers to homework problems:

### Chapter 1: Primes.

Prime numbers are whole numbers, other than 1, whose only factors in the whole numbers are 1 and the number itself. The first few primes are 2, 3, 5. The number of primes is infinite. The density of primes less than or equal to a given number n decreases as n increases. According to the Prime Number Theorem, the density of primes less than or equal to n is asymptotic to 1/log(n).

### Homework.

1. What is the second prime number?
2. How many prime numbers are there?
3. Does the probability that a given number n is prime increase or decrease as n increases?
. . . ,

### Appendix: Answers.

### Chapter 1.

1. 3.
2. Infinity.
3. Decrease.

This textbook may be automatically processed into a plurality of answerable non-generative body-question-answer data (e.g., by using a CPU and/or computational unit such as computational unit 103).

For example, prime numbers are whole numbers, other than 1, whose only factors in the whole numbers are 1 and the number itself. The first few primes are 2, 3, 5. The number of primes is infinite. The density of primes less than or equal to a given number n decreases as n increases. According to the Prime Number Theorem, the density of primes less than or equal to n is asymptotic to 1/log(n). According to this text, what is the second prime number?3.

In another example, prime numbers are whole numbers, other than 1, whose only factors in the whole numbers are 1 and the number itself. The first few primes are 2, 3, 5. The number of primes is infinite. The density of primes less than or equal to a given number n decreases as n increases. According to the Prime Number Theorem, the density of primes less than or equal to n is asymptotic to 1/log(n). According to this text, how many prime numbers are there? Infinity.

In yet another example, prime numbers are whole numbers, other than 1, whose only factors in the whole numbers are 1 and the number itself. The first few primes are 2, 3, 5. The number of primes is infinite. The density of primes less than or equal to a given number n decreases as n increases. According to the Prime Number Theorem, the density of primes less than or equal to n is asymptotic to 1/log(n). According to this text, does the probability that a given number n is prime increase or decrease as n increases? Decrease.

In addition to the specific, illustrative token sequence format above, a plethora of token sequence formats comprising non-generative training data will be apparent to those of ordinary skill in the art of preparation of training data for generative models. To provide additional guidance, an additional illustrative token sequence format for the first data item above, following the definition of non-generative training data, is provided:
Please read the following Document and answer the question at the end.
Document:
Prime numbers are whole numbers, other than 1, whose only factors in the whole numbers are 1 and the number itself. The first few primes are 2, 3, 5. The number of primes is infinite. The density of primes less than or equal to a given number n decreases as n increases. According to the Prime Number Theorem, the density of primes less than or equal to n is asymptotic to 1/log(n).
Question: In the Document, what is the second prime number?
Answer: 3.

In this example, it is assumed that the homework for each chapter is based only on the chapter itself. More generally, it is possible that the homework questions in each chapter mainly address information that is in the chapter itself, but may also depend on preceding chapters, or more generally even prerequisite materials for the textbook. In such cases, reasonable additional previous context may need to be included in each training data item, in order that the source of the extracted information is present in the body text.

Furthermore, in this example, it is assumed that the homework questions are non-generative in nature, with the answer being an individual piece of information. Depending on the subject matter and grade level of the textbook, some homework problems may require lengthy answers, such as essays. Such generative, non-non-generative homework problems should be filtered out of the training data in the first step of the process.

To create the corresponding unanswerable (e.g., non-answerable), non-generative training data items, the ways in which the extracted answer is sourced from the naturally sourced body text may be considered. In the simplest cases, the answer is literally present in the body text. In medium-complexity cases, the extracted answer may exist in a localized sequence of tokens in the body text, with essentially the same meaning, but not necessarily using the same language. In the most complex cases, some non-generative questions (e.g., non-generative tasks) require answers that logically assemble multiple pieces of information that exist in the body text, either literally or with the same meaning required for the assembly (for example, if the non-generative question were, “According to this text, what is the sum of the first 3 primes?”, the answer would require adding the numbers “2”, “3”, and “5”).

Depending on the sophistication of the ablation algorithms available, and the architecture of the underlying generative model used to build the Non-Generative, Generative Artificial Intelligence, a larger or smaller fraction of such extractions may be automatically ablated to create the unanswerable (e.g., non-answerable), non-generative training data.

At the most complex end, if the assembly of the extracted answer from one or more pieces of information in the body text requires operations beyond the abilities of the underlying Generative language model, then such questions (e.g., non-generative tasks) should be filtered out. Such operations could include, in the case of traditional, purely transformer-based generative models, mathematical calculations, or inductive logic. For example, the question, “According to this text, what is the sum of the first 3 primes?”, with the given body text, would require arithmetic. As another example, “According to this text, how many prime numbers are there?”, would require inductive logic if the text did not include a sentence making that fact explicit. Some more recent elaborations of generative Artificial Intelligence have included alternative model components in their architecture, beyond the transformer, to handle, for example, mathematical calculations. Thus, the specific abilities of the underlying generative model being used to train Non-generative, Generative Artificial Intelligence should be accounted for in this filtering decision.

Additionally, or alternatively, the computing device may use heuristic rules, machine learning classifiers, or other automated methods to determine whether a given task (e.g., question) requires operations beyond the abilities of the underlying generative model and filter out such tasks accordingly.

Conversely, if the extracted answer could be assembled from both explicitly stated source information in the body text, and also implicitly by means of operations beyond the abilities of a language model, then the ablation of just the explicit source information is sufficient to create an unanswerable (e.g., non-answerable) non-generative training data item. The generative model would then not be expected to succeed in extracting the desired information using the remaining implicit information, which may only yield the answer by means of operations beyond its abilities. For example, for the question, “According to this text, how many prime numbers are there?”, ablating the explicit source information, “The number of prime numbers is infinite”, would be sufficient, since a traditional, purely transformer-based generative model would not be expected to inductively reason that fact from the definition of prime numbers that is also present in the body text.

If multiple pieces of information are required to assemble the extracted answer, then, as long as the automated training data preparation method may identify at least one of the required pieces of information in the body text, ablating that one piece of information will be sufficient to create unanswerable (e.g., non-answerable), non-generative training data.

To make the automated ablation of the source information for an extracted answer as reliable as possible, one embodiment of the method may be to ablate only complete sentences in the body text. For example, for the question, “According to this text, what is the second prime number?”, ablating only the extracted answer itself, “3”, would result in the incoherent, ablated body text, “ . . . The first few primes are 2, 5 . . . ”, for which the now apparently “correct” answer, based on this ablated body text, would not be a non-response, as intended, but instead, “5”. By ablating complete sentences only, the ablated body text would become, “ . . . number itself. The number . . . ”, for which the correct answer the non-generative question is now a non-response (e.g., null response), such as “Unknown”, as intended.

Additionally, or alternatively, the computing device may ablate paragraphs, sections, or other logical units of text rather than individual sentences. In some embodiments, the computing device may use more sophisticated ablation algorithms that remove only the minimal amount of text necessary to make the task (e.g., question) unanswerable while preserving the coherence of the remaining body text.

Thus, applying automated processing, using only full sentence ablation, the following items of unanswerable (e.g., non-answerable), non-generative training data could be created. For illustrative purposes, all these examples have all been chosen, from within the mathematical domain, to still be extractable from the automatically ablated body text by full human intelligence, or perhaps by a more sophisticated generative model, but not by a traditional, transformer-only Generative language model. Alternatively, traditional generative models could attempt to answer these same examples using its general knowledge acquired from other training data. However, since the goal is to train Non-Generative, Generative Artificial Intelligence or configure a non-hallucinatory model, the method specifically does not want to make use of general knowledge and instead provides a non-response (e.g., null-response) in case the answer is not in the ablated body text itself. Therefore, in either case, these examples provide suitable unanswerable (e.g., non-answerable), non-generative training data items for purposes of training the Non-Generative, Generative Artificial Intelligence from such a generative model.

For example, prime numbers are whole numbers, other than 1, whose only factors in the whole numbers are 1 and the number itself. The number of primes is infinite. The density of primes less than or equal to a given number n decreases as n increases. According to the Prime Number Theorem, the density of primes less than or equal to n is asymptotic to 1/log(n). According to this text, what is the second prime number?Unknown.

In another example, prime numbers are whole numbers, other than 1, whose only factors in the whole numbers are 1 and the number itself. The first few primes are 2, 3, 5. The density of primes less than or equal to a given number n decreases as n increases. According to the Prime Number Theorem, the density of primes less than or equal to n is asymptotic to 1/log(n). According to this text, how many prime numbers are there?Unknown.

In yet another example, prime numbers are whole numbers, other than 1, whose only factors in the whole numbers are 1 and the number itself. The first few primes are 2, 3, 5. The number of primes is infinite. According to the Prime Number Theorem, the density of primes less than or equal to n is asymptotic to 1/log(n). According to this text, does the probability that a given number n is prime increase or decrease as n increases?Unknown.

### B. Enterprise Applications

There are many categories of enterprise applications in which valuable information resides in natural language text, the suitable and timely discovery and delivery of which may result in creation of significant enterprise value. Some general categories of such applications may be summarization applications and search applications.

Until now, generative models have been unable to fulfill this role, however, due to the accuracy and relevance problems described above. But given a Non-Generative, Generative Artificial Intelligence model, trained according to the method herein, this promise may now be fulfilled, by breaking down the overall enterprise task into a plurality of non-generative tasks, which may be performed accurately by the Non-Generative, Generative Artificial Intelligence, and have been selected for relevance by domain experts, and then combining and processing the extracted information for delivery to enterprise end users.

For summarization of documents, a computational unit may identify (e.g., based on information provided by users such as domain experts via one or more computing devices and/or input sources) the specific relevant pieces of information that would be valuable for the specific end users, within the context of their usage, from the type of documents in question. Then the enterprise software (e.g., software executed by and/or otherwise associated with a computational unit corresponding to an enterprise organization) may reassemble this information, provided by the Non-Generative, Generative Artificial Intelligence, into a concise and relevant summary”

As an illustrative implementation, suppose that the documents in question are startup business plans, and the end users are potential venture capital investors. These end users would be interested in different information about the business plans than, say, potential cofounders. The investors would want to know specific information such as the product, addressable market, go-to-market strategy, revenue projections, use of funds, capitalization table, and other such information. Some of this information is itself complex information that may be further broken down into non-generative tasks by experts in venture capital; for example, use of funds consists of a plurality of numbers regarding the allocation of funds to specific business expenses. Once the entire task has been decomposed into purely non-generative tasks, the extractions may be performed by the Non-Generative, Generative Artificial Intelligence, and then the extracted information may be assembled into a concise, accurate, and relevant summary, designed by and for experts in venture capital.

Additionally, or alternatively, the summarization application may be applied to other types of documents, such as legal contracts, medical records, financial reports, research papers, or any other documents containing unstructured information that may be valuable to specific end users. In some embodiments, different sets of non-generative tasks (e.g., questions) may be defined for different audiences, such that the same document may be summarized differently depending on the intended end user.

For search of a database of documents, a computational unit may identify (e.g., based on information provided by users such as domain experts via one or more computing devices and/or input sources) the specific relevant pieces of information that might be valuable in the future for end users who would like to discover relevant information in the documents. Then the enterprise database software may be used to store and index the information provided for each document by Non-Generative, Generative Artificial Intelligence, keyed to the type of information extracted. Other enterprise software may then subsequently query the database and reassemble or integrate this information into other enterprise workflows. If circumstances change, and some new piece of information is deemed relevant by domain experts, Non-Generative, Generative Artificial Intelligence may be used to extract just this new information, amend the enterprise database schema to include it, and reindex the record of the documents in the database.

As an illustrative implementation, suppose that the documents in question are the sales invoices for a business, and the end users are product managers. These end users would be interested in very different historical information than, say, financial auditors, or customer relationship managers. Product managers would want to understand historical trends of the sales of different products, and the customer segments and/or geographies buying or renewing specific products. They would likely not be interested in the invoice numbers, nor the street addresses of the customers on the invoice. Non-Generative, Generative Artificial Intelligence may be used to extract this historical information relevant to product managers, index it in a database, and connect the database to a business analytic front-end tool that enables the product managers to better understand the historical trends of product success or failure.

Additionally, or alternatively, the search and indexing application may be applied to other types of document databases, such as collections of emails, customer support tickets, regulatory filings, patent databases, or any other corpus of documents containing unstructured information. In some embodiments, the computing device may support multiple sets of non-generative tasks (e.g., questions) for the same database, enabling different end users to search for different types of information from the same set of documents.

The concepts described above in this section may be further understood by an example of a particular enterprise workflow platform augmented by a language model as described herein.

### C. Enterprise Workflow Platform

Enterprise workflows process unstructured data from selected input sources, to produce and disseminate unstructured data as reports. When the number of input sources is large, they are stored in a document database.

The third-generation language non-hallucinatory foundation models described herein may be used to make these workflows safe, reliable, and domain-relevant. The method is to decompose the information processing step into a set of hallucination-free, non-generative extractions from the input data, followed by reassembly of these extracted items into the final report. When the number of input sources is large and stored in a document database, the extracted items are precomputed and stored in an ordinary relational database.

This workflow generation platform enables each domain-specialized department to create their own workflows on demand, by specifying to the platform, for each desired workflow, via some user interface:
Input sources of unstructured data;
Items of information to be extracted from the inputs;
A template for the reassembly of the extracted information into a report;
Output sinks for the resulting structured or unstructured data.

The specification of the items of information to be extracted may be made in natural language, so long as the specification of each item takes the form of a non-generative question (e.g., non-generative task). With suitable notation, the specification of items later in the list may depend on the value of items already extracted earlier in the list. The template for the output report may be specified in a variety of standard formats.

### D. Example Use Cases

The following example use cases may illustrate the application of the non-hallucinatory model to enterprise workflows. The summarization use case described below may correspond to the method illustrated in FIG. 7, in which one or more non-generative tasks (e.g., questions) may be applied to a document, the configured model may extract information responsive to the non-generative tasks, and the extracted information may be reassembled into a summary for an end user workflow. The search use case described below may correspond to the method illustrated in FIG. 6, in which one or more non-generative tasks (e.g., questions) may be applied to a plurality of documents in a database, the configured model may extract information responsive to the non-generative tasks from each document, the extracted information may be indexed in the database for future search, and the indexed information may be subsequently retrieved in response to a query for inclusion into an end user workflow.

Summarization: Portfolio managers need timely access to key information from analyst reports as soon as they are published. The volume and length of analyst reports is such that a portfolio manager does not have time to read all of them carefully. Instead, the portfolio manager would like concise and timely summaries of the reports, targeted at their investment objectives. Asking a chatbot to summarize the reports would result in irrelevant and hallucinated information. So, the solution is to specify a workflow to the platform to deliver relevant summaries of the reports to the portfolio manager in a timely manner, by inputting into the platform's user interface:
The data feed for the analyst reports;
The specific items of information that might or might not be in an analyst report that are relevant to the portfolio manager's objectives;
A template to reassemble the specific items of information into a well formatted summary; and
The delivery channel for the formatted summary.

Search: A representative fields numerous requests for proposal (RFPs) from clients with particular investment objectives, who would like an investment plan, with specific portfolio assets, entry and exit triggers, etc., justified by the client's investment objectives. In many cases, elements of the client's investment objectives may be similar to previous clients, for whom an investment plan has been prepared. To increase productivity, representatives would like an AI agent to prepare a draft investment plan in response to an RFP, based on the plans prepared for similar clients, that the representative may use as a starting point, and save hours of research time. The solution is for the representative's department to prompt the Non-Generative, Generative AI agent to create a workflow to input new RFPs and deliver relevant investment plan drafts to the representative in a timely manner. This involves specifying to the platform two workflows: one to analyze the investment plans, and the other to analyze the RFPs. Specifying the investment plan workflow, would comprise inputting into the platform's user interface:
The email inbox to which the investment plans sent to clients are carbon copied;
The specific items of information which characterize the elements of the investment plan that are responsive to specific client investment objectives, which are used to label the elements of the plan;
The relational database in which these labeled items should be stored.
Specifying the RFP workflow would comprise inputting into the platform's user interface:
The email inbox in which the RFPs are received;
The specific items of information from the RFP that characterize the client's investment objectives;
The relational database to search for the investment plan elements, labeled by those items characterizing the investment objectives;
The template to reassemble the labeled investment plan elements into a draft investment plan; and
The email for the appropriate representative to receive the draft investment plan.

### E. Example Workflow

An example unstructured data workflow may use the open-source “enronsent” unstructured dataset, consisting of emails between Enron officers and employees leading up to the company's collapse. Personal identifying information has been replaced with “XXX”, “YYY”, or similar, in the text below, although the information does actually appear in the enronsent dataset.

The goal of the workflow is to establish a communication graph between the various personnel.

Illustrative user interface fields on the platform that could be used to specify the workflow might include:

### Input Sources:

| | |
|---|---|
| Input Database Type | filesystem |
| Input Database Name | enronsent |
| Input Database Selection Criteria | *.txt |

Non-generative items to be extracted, including references to answers to earlier questions:

| | |
|---|---|
| 1 | To whom did the author of the |
| | Document say something? |
| 2 | Provide a quote from the text |
| | showing what the author of |
| | the Document said to [1]. |
| 3 | Who said something to the |
| | author of the Document? |
| 4 | Provide a quote from the text |
| | showing what [3] said to the |
| | author of the Document. |

Report template, an example in the popular Markdown format:
#Communication Analysis
[Author] said [2] to [1]
[3] said [4] to [Author].

### Output Sinks:

| | |
|---|---|
| Output Database Type | email |
| Output Database Name | SSS |
| Output Database Metadata | Subject: Enron Communication Analysis |

Described herein are the results of running the resulting workflow on some actual entries in the database, using a third-generation foundation model (e.g., Non-Generative, Generative AI model) as described herein, including some entries where the workflow questions (e.g., tasks) are unanswerable (e.g., non-answerable), and so would normally risk hallucinations with a second-generation language model.

### Document 1

“I just spoke with XXX (subject), head of YYY's (company A) merchant arm. I told him that we had been hearing that YYY (company A) was blaming ZZZ (company B) for problems in Western gas markets. He asked for some more specifics about who exactly was spreading the rumor (I told him we had heard it from 3-4 sources). He acknowledged that EOL was not the problem; said he couldn't believe that it had been identified as such; and said he would bring it up on his call with his Washington team this afternoon.

I think he will put it to rest (except for whatever damage has already been done). I did promise to get some more specifics on who has told us that YYY (company A) pointed to us.

Can anybody give some info on that?”

### Answers 1

[1] XXX (subject)
[2] That YYY (company A) was blaming ZZZ (company B) for problems in Western gas markets
[3] XXX (subject)
[4] He would bring it up on his call with his Washington team.

### Report 1

### Communication Analysis

XXX (author) said that YYY (company A) was blaming ZZZ (company B) for problems in Western gas markets to XXX (subject).

XXX (subject) said that he would bring it up on his call with his Washington team to AAA (author).

### Document 2

“Dear XXX (subject), YYY (source) asked me to send you a reminder notice. We will be loading all the power point presentations onto 1 laptop. If you could please send me your presentation by Friday morning (5/18), it would be greatly appreciated. AAA (author) The Centers at University of Colorado-Denver 1445 Market St., Suite 380 Denver, CO 80202 phone: 303.820.AAA fax: 303.820.AAA email: XXXXX@carbon.cudenver.edu.”

### Answers 2

[1] XXX (subject)
[2]“We will be loading all the power point presentations onto 1 laptop.”
[3] YYY (source)
[4]“YYYXXXXX (source) asked me to send you a reminder notice.”

### Report 2

### Communication Analysis

AAA (author) said that We will be loading all the power point presentations onto 1 laptop to XXX (subject). YYY (source) said that YYY (source) asked me to send you a reminder notice to AAA (author).

### Document 3

“Attached is a draft of the letter we'd like to send to our 16,000 residential customers on Friday. Please review and let me know your comments by 12 noon on Wednesday.”

### Answers 3

[1] Unknown
[2]N/A
[3] Unknown
[4]N/A

### Report 3

### Communication Analysis

<blank>

Hereinafter, various characteristics will be highlighted in a set of numbered clauses or paragraphs. These characteristics are not to be interpreted as being limiting on the invention or inventive concept but are provided merely as a highlighting of some characteristics as described herein, without suggesting a particular order of importance or relevancy of such characteristics.

The following paragraphs (M1) through (M11) describe examples of methods that may be implemented in accordance with the present disclosure.

(M1) A method for training a non-hallucinatory model, comprising: selecting, by a computing device, a generative artificial intelligence model; receiving source data; generating, using the source data, augmented training data comprising one or more items of non-answerable, non-generative data; configuring, using the augmented training data, the generative artificial intelligence model for non-generative use; receiving input text and an indication of a non-generative task; causing, based on the configuring of the generative artificial intelligence model for non-generative use, the generative artificial intelligence model to output a token sequence derived from the input text by processing the input text and the non-generative task; and outputting, based on the token sequence, a non-hallucinatory answer to the non-generative task.

(M2) The method as described in paragraph (M1), wherein the non-generative task is configured to elicit a bounded response derived from the input text, the bounded response comprising one or more of: a numerical value, a name, a binary indicator, a word, a phrase, or an exact quotation from the input text.

(M3) The method as described in any of paragraphs (M1) through (M2), wherein the configuring the generative artificial intelligence model for non-generative use comprises applying the augmented training data to one or more of a pre-training step, a post-training step, a fine-tuning step, or a reinforcement learning step.

(M4) The method as described in any of paragraphs (M1) through (M3), wherein the one or more items of non-answerable, non-generative data are generated by: ablating, from body text of the source data, one or more items of information comprising elements of the body text collectively comprising an answer, by removing the one or more items of information from the body text; and replacing the answer with a null response comprising an indication that the answer is unknown, undefined, or not present in the body text.

(M5) The method as described in any of paragraphs (M1) through (M4), wherein the non-hallucinatory answer comprises at least one of: a bounded response derived from information present in the input text; or a null response indicating the information requested by the non-generative task is not present in the input text.

(M6) The method as described in any of paragraphs (M1) through (M5), further comprising: receiving one or more non-generative tasks to be applied to a plurality of documents in a database; causing, based on the one or more non-generative tasks, the configured generative artificial intelligence model to extract information responsive to the one or more non-generative tasks from each document of the plurality of documents; and indexing the extracted information in the database to be available for future search.

(M7) The method as described in any of paragraphs (M1) through (M6), further comprising: receiving a query from a user device; and retrieving, based on the query, the indexed extracted information for inclusion into an end user workflow.

(M8) The method as described in any of paragraphs (M1) through (M7), further comprising: receiving one or more non-generative tasks to be applied to a document; causing the configured generative artificial intelligence model to extract information responsive to the one or more non-generative tasks from the document; and reassembling the extracted information into a summary for an end user workflow.

(M9) The method as described in any of paragraphs (M1) through (M8), wherein receiving the source data comprises receiving the source data from a natural source comprising one or more of: textbooks, electronic documents, question-answer datasets, or observational data captured by one or more devices.

(M10) The method as described in any of paragraphs (M1) through (M9), wherein the source data comprises synthetic source data generated by: causing a generative model to generate body text; and performing at least one of: selecting, using random selection, an item or combination of items of information in the body text that provide a correct answer to a non-generative task; or determining that no item of information or combination of items of information in the body text provides a correct answer to a non-generative task.

(M11) The method as described in any of paragraphs (M1) through (M10), wherein the processing comprises: encoding, based on probability weights of the generative artificial intelligence model, the input text and the non-generative task into an embedding vector; and generating, without probabilistic extrapolation, an output token sequence derived from the input text.

The following paragraphs (CRM1) through (CRM6) describe examples of computer-readable media that may be implemented in accordance with the present disclosure.

(CRM1) One or more non-transitory computer-readable media storing instructions that, when executed by a computing system comprising at least one processor, a communication interface, and memory, cause the computing system to: select a generative artificial intelligence model; receive source data; generate, using the source data, augmented training data comprising one or more items of non-answerable, non-generative data; configure, using the augmented training data, the generative artificial intelligence model for non-generative use; receive input text and an indication of a non-generative task; cause, based on the configuring of the generative artificial intelligence model for non-generative use, the generative artificial intelligence model to output a token sequence derived from the input text by processing the input text and the non-generative task; and output, based on the token sequence, a non-hallucinatory answer to the non-generative task.

(CRM2) The one or more non-transitory computer-readable media as described in paragraph (CRM1), wherein the non-generative task is configured to elicit a bounded response derived from the input text, the bounded response comprising one or more of: a numerical value, a name, a binary indicator, a word, a phrase, or an exact quotation from the input text.

(CRM3) The one or more non-transitory computer-readable media as described in any of paragraphs (CRM1) through (CRM2), wherein the configuring the generative artificial intelligence model for non-generative use comprises applying the augmented training data to one or more of a pre-training step, a post-training step, a fine-tuning step, or a reinforcement learning step.

(CRM4) The one or more non-transitory computer-readable media as described in any of paragraphs (CRM1) through (CRM3), wherein the non-hallucinatory answer comprises at least one of: a bounded response derived from information present in the input text; or a null response indicating the information requested by the non-generative task is not present in the input text.

(CRM5) The one or more non-transitory computer-readable media as described in any of paragraphs (CRM1) through (CRM4), wherein the null response comprises an indication that the non-hallucinatory answer is unknown, undefined, or not present in a body text.

(CRM6) One or more non-transitory computer-readable media storing instructions that, when executed by a computing system comprising at least one processor, a communication interface, and memory, cause the computing system to perform the method as described in any of paragraphs (M1) through (M11).

The following paragraphs (S1) through (S5) describe an example of a system of devices that may be implemented in accordance with the present disclosure.

(S1) A system for training a non-hallucinatory model, comprising: at least one actuator; and a computational unit, wherein the computational unit comprises memory storing one or more computer-readable instructions that, when executed, cause the system to: select a generative artificial intelligence model; receive source data; generate, using the source data, augmented training data comprising one or more items of non-answerable, non-generative data; configure, using the augmented training data, the generative artificial intelligence model for non-generative use; receive input text and an indication of a non-generative task; cause, based on the configuring of the generative artificial intelligence model for non-generative use, the generative artificial intelligence model to output a token sequence derived from the input text by processing the input text and the non-generative task; and output, based on the token sequence, a non-hallucinatory answer to the non-generative task.

(S2) The system as described in paragraph (S1), wherein the instructions further cause the system to: receive one or more non-generative tasks to be applied to a document; cause the configured generative artificial intelligence model to extract information responsive to the one or more non-generative tasks from the document; and reassemble the extracted information into a summary for an end user workflow.

(S3) The system as described in any of paragraphs (S1) through (S2), wherein receiving the source data comprises receiving the source data from a natural source comprising one or more of: textbooks, electronic documents, question-answer datasets, or observational data captured by one or more devices.

(S4) The system as described in any of paragraphs (S1) through (S3), wherein the source data comprises synthetic source data generated by: causing a generative model to generate unablated body text; and performing at least one of: selecting, using random selection, an item or combination of items of information in the body text that provide a correct answer to a non-generative task; or determining that no item of information or combination of items of information in the body text provides a correct answer to a non-generative task.

(S5) A system comprising: a computing device configured to perform the method as described in any of paragraphs (M1) through (M11); and at least one actuator.

The following paragraph (AI) describes examples of computing systems that may be implemented in accordance with the present disclosure.

(A1) A computing system comprising: one or more processors; and memory storing computer executable instructions that, when executed by the one or more processors, cause the computing system to perform the method as described in any of paragraphs (M1) through (M11).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for training a non-hallucinatory model, comprising:
selecting, by a computing device, a generative artificial intelligence model;
receiving source data;
generating, using the source data, augmented training data comprising one or more items of non-answerable, non-generative data;
configuring, using the augmented training data, the generative artificial intelligence model for non-generative use;
receiving input text and an indication of a non-generative task;
causing, based on the configuring of the generative artificial intelligence model for non-generative use, the generative artificial intelligence model to output a token sequence derived from the input text by processing the input text and the non-generative task; and
outputting, based on the token sequence, a non-hallucinatory answer to the non-generative task.

2. The method of claim 1, wherein the non-generative task is configured to elicit a bounded response derived from the input text, the bounded response comprising one or more of: a numerical value, a name, a binary indicator, a word, a phrase, or an exact quotation from the input text.

3. The method of claim 1, wherein the configuring the generative artificial intelligence model for non-generative use comprises applying the augmented training data to one or more of a pre-training step, a post-training step, a fine-tuning step, or a reinforcement learning step.

4. The method of claim 1, wherein the one or more items of non-answerable, non-generative data are generated by:
ablating, from body text of the source data, one or more items of information comprising elements of the body text collectively comprising an answer, by removing the one or more items of information from the body text; and
replacing the answer with a null response comprising an indication that the answer is unknown, undefined, or not present in the body text.

5. The method of claim 1, wherein the non-hallucinatory answer comprises at least one of:
a bounded response derived from information present in the input text; or
a null response indicating the information requested by the non-generative task is not present in the input text.

6. The method of claim 1, further comprising:
receiving one or more non-generative tasks to be applied to a plurality of documents in a database;
causing, based on the one or more non-generative tasks, the configured generative artificial intelligence model to extract information responsive to the one or more non-generative tasks from each document of the plurality of documents; and
indexing the extracted information in the database to be available for future search.

7. The method of claim 6, further comprising:
receiving a query from a user device; and
retrieving, based on the query, the indexed extracted information for inclusion into an end user workflow.

8. The method of claim 1, further comprising:
receiving one or more non-generative tasks to be applied to a document;
causing the configured generative artificial intelligence model to extract information responsive to the one or more non-generative tasks from the document; and
reassembling the extracted information into a summary for an end user workflow.

9. The method of claim 1, wherein receiving the source data comprises receiving the source data from a natural source comprising one or more of: textbooks, electronic documents, question-answer datasets, or observational data captured by one or more devices.

10. The method of claim 1, wherein the source data comprises synthetic source data generated by:
causing a generative model to generate body text; and
performing at least one of:
selecting, using random selection, an item or combination of items of information in the body text that provide a correct answer to a non-generative task; or
determining that no item of information or combination of items of information in the body text provides a correct answer to a non-generative task.

11. The method of claim 1, wherein the processing comprises:
encoding, based on probability weights of the generative artificial intelligence model, the input text and the non-generative task into an embedding vector; and
generating, without probabilistic extrapolation, an output token sequence derived from the input text.

12. One or more non-transitory computer-readable media storing instructions that, when executed by a computing system comprising at least one processor, a communication interface, and memory, cause the computing system to:
select a generative artificial intelligence model;
receive source data;
generate, using the source data, augmented training data comprising one or more items of non-answerable, non-generative data;
configure, using the augmented training data, the generative artificial intelligence model for non-generative use;
receive input text and an indication of a non-generative task;
cause, based on the configuring of the generative artificial intelligence model for non-generative use, the generative artificial intelligence model to output a token sequence derived from the input text by processing the input text and the non-generative task; and
output, based on the token sequence, a non-hallucinatory answer to the non-generative task.

13. The one or more non-transitory computer-readable media of claim 12, wherein the non-generative task is configured to elicit a bounded response derived from the input text, the bounded response comprising one or more of: a numerical value, a name, a binary indicator, a word, a phrase, or an exact quotation from the input text.

14. The one or more non-transitory computer-readable media of claim 12, wherein the configuring the generative artificial intelligence model for non-generative use comprises applying the augmented training data to one or more of a pre-training step, a post-training step, a fine-tuning step, or a reinforcement learning step.

15. The one or more non-transitory computer-readable media of claim 12, wherein the non-hallucinatory answer comprises at least one of:
a bounded response derived from information present in the input text; or
a null response indicating the information requested by the non-generative task is not present in the input text.

16. The one or more non-transitory computer-readable media of claim 15, wherein the null response comprises an indication that the non-hallucinatory answer is unknown, undefined, or not present in a body text.

17. A system for training a non-hallucinatory model, comprising:
at least one actuator; and
a computational unit, wherein the computational unit comprises memory storing one or more computer-readable instructions that, when executed, cause the system to:
select a generative artificial intelligence model;
receive source data;
generate, using the source data, augmented training data comprising one or more items of non-answerable, non-generative data;
configure, using the augmented training data, the generative artificial intelligence model for non-generative use;
receive input text and an indication of a non-generative task;
cause, based on the configuring of the generative artificial intelligence model for non-generative use, the generative artificial intelligence model to output a token sequence derived from the input text by processing the input text and the non-generative task; and
output, based on the token sequence, a non-hallucinatory answer to the non-generative task.

18. The system of claim 17, wherein the instructions further cause the system to:
receive one or more non-generative tasks to be applied to a document;
cause the configured generative artificial intelligence model to extract information responsive to the one or more non-generative tasks from the document; and
reassemble the extracted information into a summary for an end user workflow.

19. The system of claim 17, wherein receiving the source data comprises receiving the source data from a natural source comprising one or more of: textbooks, electronic documents, question-answer datasets, or observational data captured by one or more devices.

20. The system of claim 17, wherein the source data comprises synthetic source data generated by:
causing a generative model to generate unablated body text; and
performing at least one of:
selecting, using random selection, an item or combination of items of information in the body text that provide a correct answer to a non-generative task; or
determining that no item of information or combination of items of information in the body text provides a correct answer to a non-generative task.
